(19) United States
(12) Patent Application Publication
(10) Pub. No.: US 2025/0217467 A1
(43) Pub. Date: Jul. 3, 2025

(54) SYSTEMS AND METHODS FOR DYNAMIC AUTHENTICATION ACROSS DISPARATE SYSTEMS

(71) Applicant: Synchrony Bank, Stamford, CT (US)

(72) Inventors: Brijendra Awasthi, Cleveland, OH (US); Deborah Bernert, Stamford, CT (US); Heather Frey, Atlanta, GA (US); Chris Otten, Columbus, OH (US); Derk Doijer, New York, NY (US); Patrick Breslin, Cincinnati, OH (US); Abhijeet Tekade, Chicago, IL (US); Rahul Kulkarni, Austin, TX (US); Upul Gunasena, Houston, TX (US)

(73) Assignee: Synchrony Bank, Stamford, CT (US)

(21) Appl. No.: 19/004,258

(22) Filed: Dec. 28, 2024

Related U.S. Application Data
(60) Provisional application No. 63/616,069, filed on Dec. 29, 2023.

(51) Int. Cl. G06F 21/33

(52) U.S. Cl. CPC G06F 21/33; G06F 2221/2149

(57) ABSTRACT

An authentication system may enable remote access to multiple user profiles of a user with a single authentication. The authentication system may receive a connection request including personal identifiable information associated with a current user of a user device. The authentication system may select an authentication process from a plurality of authentication processes based on at least a portion of the personal identifiable information. Once authenticated, the authentication system may establish a temporary session for the user device, enabling execution of an action one or more user profiles.

### CROSS-REFERENCE TO RELATED APPLICATIONS

The present patent application claims the benefit of priority to U.S. Provisional Patent Application 63/616,069 filed Dec. 29, 2023, which is incorporated herein by reference in its entirety for all purposes.

### TECHNICAL FIELD

This disclosure relates generally to user authentication and more specifically to dynamically authenticating users based on requested access to disparate systems.

### BACKGROUND

Many service providers enable access to services via a native application. The applications enable different degrees of security (e.g., to protect financial, personal identifiable information, privacy, etc.) and services depending on the particular device executing the application. Native applications can provide some benefits such as offloading data processing and storage onto user devices, providing persistent user identification (e.g., user authentication, etc.), providing offline access to data associated with a service or service provider, etc. However, in some cases, native applications may also expose user information to unknown third parties and capture information without the knowledge or consent of the user.

In addition, users who may interact and subscribe to many different services may be pushed to download an application for each service. The multitude of applications may consume a significant portion of the processing resources of the user device and impact performance of the user device's native operations as well as the applications.

### SUMMARY

Methods are described herein for authenticating users using personal identifiable information. The methods can include: receiving, through a web-based interface, a connection request from a user device, wherein the connection request includes personal identifiable information associated with a current user of the user device; selecting an authentication process from a plurality of authentication processes based on at least a portion of the personal identifiable information. authenticating the user device by executing the authentication process using the portion of the personal identifiable information; establishing a temporary session for the user device, the temporary session enabling execution of one or more actions associated with one or more user profiles; and facilitating execution of at least one action of the one or more actions.

In some examples, the methods may further include: wherein the one or more user profiles correspond to accounts associated with the current user of the user device.

In some examples, the methods may further include: wherein the one or more actions are determined based on the authentication process.

In some examples, the methods may further include: wherein the at least one action pushes a token into a secure environment of the user device, the token enabling access to a resource associated with a user profile of the one or more user profiles.

In some examples, the methods may further include: wherein the at least one action includes a request to increase a resource associated with a user profile of the one or more user profiles.

In some examples, the methods may further include: identifying, using the personal identifiable information, the one or more user profiles associated with the current user of the user device, wherein selecting an authentication process is further based on the one or more user profiles.

In some examples, the methods may further include: wherein the authentication process includes transmitting a request to the user device for information associated with a user profile of the one or more user profiles.

In some examples, the methods may further include: wherein the authentication process includes transmitting a request to the user device for additional personal identifiable information.

In some examples, the methods may further include: wherein the authentication process includes requesting one or more images of a physical identification card associated with the current user.

In some examples, the methods may further include: determining that the authentication process failed to authenticate the user device; establishing a connection with the user device over a second communication channel; and executing another authentication process over the second communication channel.

Systems described herein for authenticating users using personal identifiable information. The systems may include one or more processors and a non-transitory computer-readable medium storing instructions that, when executed by the one or more processors, cause the one or more processors to perform any of the methods as previously described.

The non-transitory computer-readable media described herein may store instructions which, when executed by one or more processors, cause the one or more processors to perform any of the methods as previously described.

These illustrative examples are mentioned not to limit or define the disclosure, but to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 illustrates a block diagram of example user authentication system according to aspects of the present disclosure.

FIG. 2 illustrate a flowchart of an example process for identifying user records based on one or more identifiers according to aspects of the present disclosure.

FIG. 3 illustrates a block diagram of an example user authentication system configured to identify and authenticate requests based one or more identifiers according to aspects of the present disclosure.

FIG. 4 illustrate example user interfaces enabling execution of various actions associated user profiles based on user authentication according to aspects of the present disclosure.

FIG. 5 illustrate a block diagram of a D2D process for authenticating an according illustrate to aspects of the present disclosure.

FIG. 6 illustrates a block diagram of a process for identifying user records using D2D according to aspects of the present disclosure.

FIG. 7 illustrates a block diagram of a process for identifying user records using PII according to aspects of the present disclosure.

FIG. 8 illustrates a flowchart of an example process for authenticating users across disparate systems according to aspects of the present disclosure.

FIG. 9 illustrates a flowchart of an example process for authenticating user devices over unsecured communication channels according to aspects of the present disclosure.

FIG. 10 illustrates an example computing device architecture of an example computing device that can implement the various techniques described herein according to aspects of the present disclosure.

### DETAILED DESCRIPTION

Service providers may establish a user profile for users accessible via access credentials (e.g., username and password, etc.). The user may access the user profile through one or more channels (e.g., website, telephone, etc.) to execute various operations associated with the user profile (e.g., modify personal identifiable information, view balances or activity, request additional resources associated with the user profile, etc.). In some instances, service providers may provide a native application that allows users to access the user profile and execute the various operations. As more service providers provide native applications, the multitude of native applications can consume a larger portion of the processing resources of the user device (e.g., volatile/non-volatile memories, central processing unit cycles, network bandwidth, etc.) negatively impacting the performance of the user device.

The methods and systems described herein identify and authenticate users enabling access each of the one or more user profiles associated with particular user in a single instance and with a single authentication process. The authentication system may be accessed through various temporary channels to allow for ad-hoc access to the one or more user profiles. As a result, the authentication system can be accessed through channels other than a static, native application executing on a user device. In some instances, the authentication system can be accessed through an application associated with a particular user profile of the one or more user profiles associated with the user. For example, a user device may include an application configured to manage a user profile associated with a first service provider. The application may be modified to include instructions that, when executed, establish a connection with the authentication system, enabling the authentication system to use the user authentication of the application to authenticate the user device and access the other user profiles associated with other service providers as well as the user. The other service providers may not be affiliated with the service provider associated with the application, but each of the service providers may be associated with the authentication system.

The temporary channels may be established before accessing the authentication system and terminate upon accessing the authentication system, sometime after accessing the authentication system and before the session with the authentication system terminates, or some time after the session with the authentication system terminates. In some instances, the temporary channel may be a same channel type as the channel used to access the authentication system. For instance, a user device may establish a temporary channel via a web-based interface (e.g., a web browser, etc.) and establish a session with the authentication system via a parallel web-based interface. In other instances, the temporary channel may be a different channel type. For example, the temporary channel may be a telephonic connection (e.g., between a user device and an agent of a service provider, call center, etc.) and the session with the authentication system may be established via a web-based interface of the user device (or another device associated with a same user). The temporary channel may be established by the user device via a website, a quick response code (e.g., associated with a service provider, the authentication system, etc.), telephony, a link provided via a text message or email, instant or direct messaging, and/or the like. For example, a service provider may present a QR code that can be executed by a user device to establish a session with the authentication system.

Over the temporary channel, a user device may establish a session with an authentication system to access a plurality of user profiles associated with the user within a single interface of the authentication system. The session with the authentication system may be established over a web-based interface without executing local instructions (e.g., by downloading and executing a native application, etc.). The authentication system may use information received while establishing the session or received after the session is established to identify the user device and/or the user thereof. The authentication system may use personal identifiable information (e.g., name, address, social security number, phone number, etc.) to identify one or more user profiles associated with the user device or the user thereof. In some instances, the authentication system may request one or more identifiers associated with the user (e.g., a globally unique identifier such as a social security number or the like, a phone number or other communication-based identifier, etc.). If the authentication cannot identify the one or more user profiles using the one or more identifiers, the authentication may request personal identifiable information that can be used to identify at least one user profile associated with the user device and/or the user thereof. The authentication system may then identify additional user profiles associated with the same user device and/or the user thereof using information from the at least one user profile (e.g., other personal identifiable information, account numbers, etc.).

In some instances, the authentication system may use one or more machine-learning models configured to predict an identity of the user device, an identity of the user of the user device, and/or predict user profiles associated with the user device and/or the user thereof. The one or more machine-learning models may also be configured to correlate user profiles to identify two or more user profiles that may be associated with a same user device and/or user. The authentication system may derive features from information received from the user device to establish the session and information requested by the authentication system to identify the user device (e.g., such as, but not limited to, the GUID, and phone number, as previously described). The machine-learning model may then generate a feature vector for input to the one or more machine-learning models. The one or more machine-learning models may be configured to predict the identity of the user device and/or the user thereof by processing the feature vector. The authentication system may then identify the one or more user profiles associated with the identified user device and/or user thereof (e.g., using lookup tables, database queries, etc.). Alternatively, or additionally, the one or more machine-learning models may be configured to identify one or more user profiles associated with the user device and/or the user device by processing the feature vector. The one or more machine-learning models may predict an association between the user device and/or the user thereof and a user profile with a confidence value indicative of relative accuracy of the prediction. The user profiles with a confidence value that is greater than a threshold may be determined to correspond to the user device and/or the user thereof.

Examples of machine-learning models include algorithms such as k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, metalearning, reinforcement learning, deep learning, and other such algorithms and/or methods.

In some instances, the machine-learning model may be trained using training data received and/or derived from the user profiles, from historical sessions (e.g., involving the user device and/or the user thereof, involving other user devices and/or other users thereof, and/or the like), from interactions with an agent or virtual agent, and/or the like. In some instances, the training data or portions thereof may be manually generated. In some instances, the training data or portions thereof may be generated procedurally (e.g., automatically) using random number generators, hash functions, etc. and historical sessions. For example, historical sessions may be analyzed to determine a range of features that may be included in a session. The historical session data may be used to define, for each feature, a range of possible values for that feature based on observed values of that data type. The random number generator, for example, may then be used to generate a fake historical session by pseudo randomly selecting features to include in a fake historical session as well as the values for each feature to be included. For some types of learning such as supervised learning, the training data can be labeled as corresponding to particular user profiles, particular user device and/or users, etc. The machine-learning model can be trained using supervised training, supervised training, semi-supervised training, reinforcement training, combinations thereof, or the like.

For example, the machine-learning model may be trained using transfer learning. Transfer learning may initially train a machine-learning model to solve a particular task as the starting point for training the machine-learning model to perform different task. Transfer learning can be useful when the second task is somewhat similar to the first task, or when there is limited training data available for the second task. For example, a machine-learning model initially trained to recognize a particular user device can be further trained to predict two or more user profiles that may be associated with a common device or user. In some instances, the machine-learning models may access a pre-trained model and “fine-tune” the pre-trained model by training it on a second training dataset. The second training dataset can include training data that are labeled as corresponding to a particular user profile. To further fine-tune the machine-learning model, the machine-learning model may be reconfigured to include additional hidden and/or output layers to predict an association between two or more user profiles. In some instances, fine-tuning the pre-trained model includes unfreezing some of the layers of the pre-trained model and training them on the new training dataset. The number of layers that are unfrozen can depend on the size of the new dataset and how similar it is to the original dataset. For example, the fine-tuning of the machine-learning model can include freezing the weights of the machine-learning model, to train the machine-learning model to predict an association between two or more user profiles. Then, the weights can be unfrozen such that the machine-learning model can be trained to improve accuracy of the classification.

Once the authentication system identifies the user profiles associated with the user device and/or the user thereof, the authentication system may authenticate the user device (e.g., authenticate the identity of the user device or the user operation the user device. The authentication system may use one or more authentication processes to authenticate the user device and/or the user thereof. In some instances, the authentication system may select an authentication process based on a primary user profile of identified user profiles. The primary user profile may be a user profile associated with the service provider that initiated the session with the authentication system (if the session was initiated by a service provider). Alternatively, the primary user profile may be a first user profile that is identified when identifying user profiles. The authentication system may select the authentication process based on the primary user profile. Alternatively, or additionally, the authentication process may be selected based on an operation to be executed in association with a user profile. For example, upon identifying the user profiles the authentication system may request a selection of an operation and select an authentication process based on the operations.

Examples of authentication processes include, but are not limited to, using the personal identifiable information (e.g., information received during initiation of the session or requested after establishing the session, etc.), username and password, a direct to device process (D2D) (e.g., where the authentication system may transmit a code or link to the user device or to a device associated with the primary user profile or another user profile of the identified user profiles), a token (e.g., previously provided authentication code, hash, instruction set, etc.), TrustStamp (e.g., one or more images of a physical identifier of the user), or other information. In some instances, the authentication processes may be defined as a hierarchy based on a confidence that the authentication process accurately authenticates a user device and/or the user thereof. For example, authenticating the user device and/or the user thereof using personal identifiable information (e.g., by comparing the personal identifiable information to corresponding information of the identified user profiles) may be less secure than a D2D process, and a D2D process may be less secure than a TrustStamp process. The authentication process may be selected based on the degree in which the primary user profile and/or the operation to be executed are dependent on the degree of authentication.

Once a user is authenticated, the user may facilitate execution of various operations associated with any of the one or more user profiles through an interface of the authentication system. Examples of operations include, but are not limited to, provisioning a secure environment (e.g., a wallet, etc.) within a user device with token associated with a resource of a user profile, request a status of a user profile or a resource associated with a user profile, request an increase in resources associated with a user profile, request a new resource associated with a user profile, provide resources, access a virtual assistant associated with a particular user profile, access a virtual agent associated with the one or more user profiles, access an agent (e.g., a customer service representative) associated with a particular user profile, access an agent associated with the authentication system, combinations thereof, or the like. For example, a user device may connect to the authentication system and, upon being authenticated, provision a token (e.g., a live token corresponding to a resource, a single-use token corresponding to a resource, a virtual token corresponding to a resource, etc.) into a secure environment within the user device. Once provisioned, the user device may access the resource at a terminal device using the token and a secured communication process between the user device and the terminal device (e.g., near-field communication (NFC), or the like). The user can access a plurality of user profiles associated with the user at once and execute operations associated with individual user profiles from an interface of the authentication system without individually authenticating the user for each user profile or using client-side processing (e.g., a native application, etc.).

Once an operation is executed, the authentication system may request a selection of a subsequent operation. If the subsequent operation depends on a higher degree of authentication than the executed authentication processes, then the authentication system may execute a new authentication process selected based on the selected subsequent operation. If the subsequent operation depends on a same or lower degree of authentication, then the authentication system may execute the subsequent operation. If no subsequent operation is selected, then the session with the authentication system may terminate. Upon termination, the user device may be returned to the temporary channel. For example, if the temporary channel is a telephony channel, then the user device may be reconnected to the temporary channel enabling the user device to continue communicating with an agent, virtual agent, etc.

In an illustrative example, a computing device may receive a connection request from a user device through a web-based interface. In some instances, the user device may access the web-based interface through one or more temporary channels such as, but not limited to, instant messaging, direct messaging, telephony, etc. associated with an agent and/or virtual agent (e.g., large language model, natural language model, other machine-learning models, etc.). In other instances, the user device may access the web-based interface via a web browser, an executable link (e.g., provided via text messaging, instant messaging, email, etc.), a QR code, and/or the like. The connection request may include personal identifiable information associated with a current user of the user device. For example, the personal identifiable information may include, but is not limited to, a name of the user, a globally unique identifier (e.g., a social security number, an identifier previously assigned by the computing device to the user and/or the user device, etc.), a communication address (e.g., phone number, Internet Protocol (IP) or Media Access Control (MAC) address, email address, etc.), a physical address associated with the user (e.g., a mailing address, etc.), an identification of one or more user profiles associated with the user, an identification of data stored in the one or more user profiles, and/or the like.

The computing device may use the personal identifiable information to identify one or more user profiles associated with the user device and/or the user. In some instances, the computing device may first identify a primary user profile. The primary user profile may be a user profile associated with how the user device and/or the user established the connection request with the computing device. For example, a QR code may be provided by a service provider with which the user has a user profile. The QR may include an identification of the service provider that provided the QR code and/or the user profile of the service provider such that executing the QR may indicate, to the computing device, the service provider and/or the user profile associated with the user device and/or the user. Alternatively, the computing device may request an identification of a primary user profile from the user device. Alternatively still, the computing device may perform a search to identify the user profiles associated with the user device and/or the user (e.g., using the personal identifiable information, additional personal identifiable information requested from the user device and/or the user, etc. and search logic such as, but not limited to, structured queries, database tables, a machine-learning model, etc.).

After identifying a first user profile, the computing device may confirm that the first user profile corresponds to the user device and/or the user by for example, transmitting a code to a device identified in the user profile and requesting the code from the user device. Alternatively, the computing device may confirm that the first user profile corresponds to the user device and/or the user by requesting the information that corresponds to information stored in the first user profile (e.g., personal identifiable information, a date in which the first user profile was established, a date in which the first user profile was last accessed, an identifier of the first user profile, etc.). If the first user profile is confirmed to be associated with the user device and/or the user, the computing device may determine that the first user profile is the primary user profile for this session between the user device and the computing device. If the first user profile is not confirmed to be associated with the user device and/or the user, then the computing device may identify a next user profile and confirm that user profile. The process may continue until a user profile can be confirmed as being associated with the user device and/or the user or until there are no more user profiles that match the personal identifiable information. If there are no more user profiles that match the personal identifiable information and that can be confirmed as being associated with the user device and/or the user device, then the computing device may store the personal identifiable information and information associated with the user device (e.g., a device identifier, hardware installed on the device, software installed on the device, an IP address of the device, a MAC address of the device, an communication address of the device such as a phone number or the like, combinations thereof, or the like) in case it is determined the user of the user device fraudulently attempted to access user profiles associated with another user.

The computing device may use the primary user profile to identify one or more other user profiles associated with the user. Each user profile may be associated with a service provider that established the user profile. In some examples, one or more user profiles may be associated with a same service provider as another user profile. In some instances, the primary user profile may store an identification of the one or more other user profiles. In other instances, the computing device may use the personal identifiable information as well as information in the primary user profile to identify the one or more other user profiles. Identifying the one or more other user profiles may include database tables, structured queries, machine-learning models, user input (e.g., from the user of the user device, etc.), combinations thereof, and the like.

The computing device may select an authentication process from a plurality of authentication processes based on at least a portion of the personal identifiable information, the primary user profile, the one or more other user profiles, an action to be executed in association with a user profile, combinations thereof, or the like. For example, the authentication process may be selected based on a security level identified by the computing device, the primary user profile, the one or more other user profiles, a service provider associated with the primary user profile or the one or more other user profiles, an action to be executed in association with a user profile, etc. Examples of authentication processes include, but are not limited to, using the personal identifiable information (e.g., information received during initiation of the session or requested after establishing the session, etc.), a username and password, a token (e.g., previously provided by the computing device, a service provider associated with the action or the primary user profile or one or more other user profiles, or the like), a direct to device process (D2D) (e.g., where the authentication system may transmit a code or link to the user device or to a device associated with the primary user profile or another user profile of the identified user profiles), TrustStamp (e.g., one or more images of a physical identifier of the user), or other information. In some instances, the authentication processes may be defined as a hierarchy based on a security level associated with the authentication process. The security level may be indicative of a confidence that the authentication process accurately authenticates a user device and/or the user thereof. For example, authenticating the user device and/or the user thereof using personal identifiable information (e.g., by comparing the personal identifiable information to corresponding information of the identified user profiles) may be less secure than a D2D process and a D2D process may be less secure than a TrustStamp process.

The computing device may then authenticate the user device and/or the user thereof by executing the selected authentication process.

The computing device may establish a temporary session for the user device in response to authenticating the user device and/or the user thereof. The temporary session may execution of one or more actions associated with one or more user profiles. Examples of actions that may be executed include, but are not limited to, any of the operations as previously described. The computing device may receive input identifying an action to be executed and a particular user profile for which the action is to be executed against.

The computing device may then facilitate execution of at least one action of the one or more actions. In some instances, facilitating execution of an action may include provisioning a secure environment within the user device with a token associated with a resource of the particular user profile or a virtual token associated with the resource of the particular user profile. Once provisioned, the user device may access the resource using the token or virtual token via NFC. By provision the secure environment via the computing device, a user may access the resource associated with the user profile without having physical access of the physical card associated with the user profile. In other instances, facilitating execution of an action may include executing the action by the computing device. In still yet other instances, facilitating execution of an action may include transmitting a communication to a service provider associated with the particular user profile causing the service provider to execute the action on behalf of the computing device. The service provider may transmit a response updating the user profile based on the execution of the action.

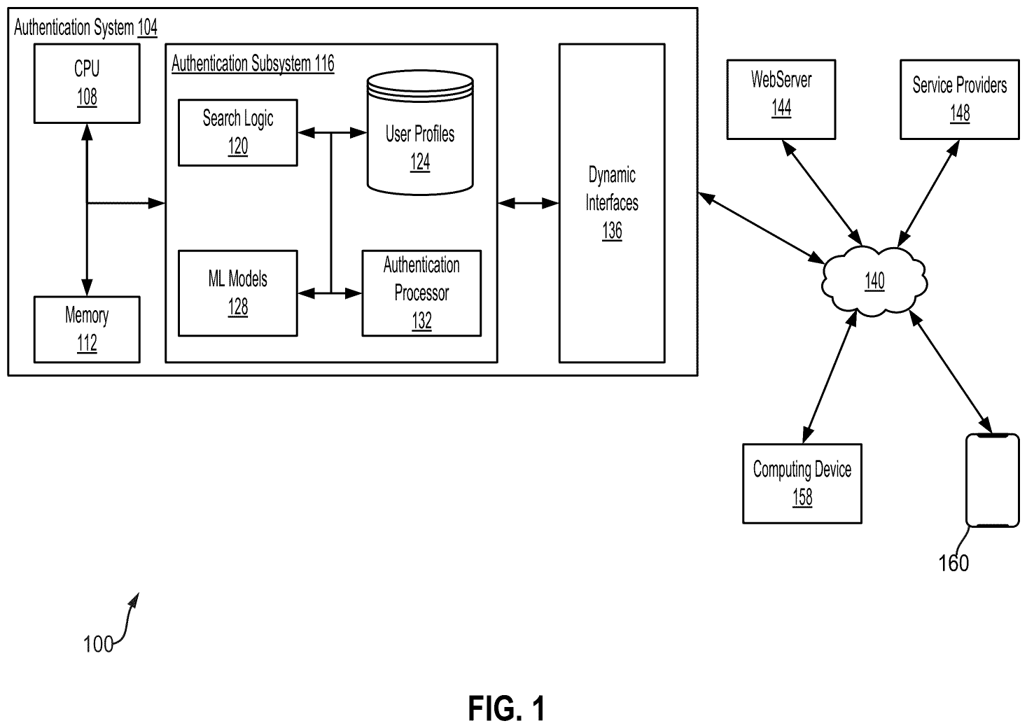

FIG. 1 illustrates a block diagram of example user authentication system according to aspects of the present disclosure. Authentication system 104 may be a component of a resource allocation and management system that manages resource allocation for service providers 148. Service providers 148 may provide objects and/or services to users and/or user devices over network 140 and/or at one or more physical locations. In some instances, service providers 148 may provide resources to user devices and/or users thereof to enable access to the objects or services provided by a service provider. The resource allocation and management system may manage access and use (e.g., allocations, etc.) of the resources by a particular user on behalf of the service provider.

When a new user registers with a service provider, the service provider may generate a user profile that includes an identification of the user, demographic information corresponding to the user, an identification of a resource or set of resources available to the user, information associated with the resource or set of resources (e.g., historical resource allocations, available resources, etc.), one or more tokens (e.g., a secure object configured to provide access to the resource, etc.), combinations thereof, or the like. The service provider may transmit an instance (e.g., a copy, etc.) of the user profile, a portion of an instance of the user profile, or an identification of the user profile (e.g., an identifier of the user profile, a hash of the user profile, a pointer or address of the user profile, etc.), or the like with the resource allocation and management system to enable the resource allocation and management system to provide services to both the service provider and the new user.

Authentication system 104 may provide authentication and security for resources allocated by the resource allocation and management system. Authentication system 104 may include processing hardware (e.g., central processing unit 108, memory 112 such as volatile and/or non-volatile memories, etc.), an authentication subsystem 116, and interfaces 136. In some instances, authentication subsystem 116 may be a hardware component of authentication system 104. For example, authentication subsystem 116 may be an application-specific integrated circuit (ASIC), field-programmable gate array (FPGA) or mask-programmable gate array (MPGA), graphics processing units (GPUs), combinations thereof, or the like. In other instances, authentication subsystem 116 may be implemented as software stored in memory (e.g., such as memory 112 or other non-volatile memory) and executed by CPU 108. In other instances, authentication subsystem 116 may include software and/or a combination of software (e.g., stored within a memory that may be executed by CPU 108, etc.) and hardware component. For example, authentication subsystem 116 may include some instructions that may be executed by CPU 108 and some components (e.g., such ML models 128, etc.) that are executed by a customized hardware GPU configuration. The customized hardware GPU configuration may be an independent parallel environment to CPU 108 configured to execute repetitive tasks such as, but not limited to, training machine-learning models, executing machine-learning models, etc.).

A physical or wireless interlink may connect CPU 108 and authentication subsystem 116. The physical or wireless interlink may enable messaging between CPU 108 and authentication subsystem 116 (e.g., passing data between contexts, interrupts, exception handling, etc.). In some examples, the messaging may be implemented through a shared memory pool. For example, memory 112 may include a shared address space accessible to both CPU 108 and authentication subsystem 116. Messages may be passed storing data within particular address ranges of the shared pool of memory. Memory 112 may include a management routine that may manage the shared pool of memory by implementing locks (or the like) to control reads and writes (e.g., ensuring address blocks cannot be written to when being used by CPU 108 or authentication subsystem 116, etc.). In other examples, messaging may be implemented by passing signals over the physical or wireless interlink.

Authentication subsystem 116 may include search logic 120, user profiles 124, ML models, and authentication processor 132. User profiles 124 may store an instance of the user profiles generated by service providers 148, a portion of an instance of the user profiles generated by service providers 148, or an identification of the user profiles generated by service providers 148. Authentication subsystem 116 may access information associated with user profiles by accessing user profiles 124 and/or by requesting access to the information using identifiers associated with a user profile (stored in user profiles 124).

Authentication system 104 may receive an authentication request from a user device (e.g., computing device 158, mobile device 160, etc.) to authenticate the user device enabling the user device to execute one or more actions in association with a user profile. For example, a user may visit a physical location of a service provider to acquire objects or services provided by the service provider. If the user does not have access to the physical credit card that provides access to the resource of the user profile associated with the service provider. The user may access authentication system 104 through the user device to provision the user device with a virtual token representing the physical card enabling access to the resource without the physical card.

The authentication request may include an identification of the user device and/or the user (e.g., a device identifier, network address information such as an IP address or MAC address, an user identifier such as a user name, social security number, a communication address, etc.), an identification of an operation that is to be executed in association with a user profile, an identification of the user profile or the service provider associated with the user profile, combinations thereof, or the like.

Authentication subsystem 116 may identify one or more user profiles associated with the authentication request using search logic 120. Search logic 120 includes instructions that execute to obtain information associated with the user device and/or the user from within authentication system 104 and/or a connected service provider.

If the authentication request includes an identification of a user profile, then search logic 120 may assign the user profile as a primary user profile (for this session) and use the authentication request and information in the primary user profile to identify one or more additional user profiles associated with the same user and/or user device.

If the authentication request includes an identification of a service provider that initiated the request (e.g., via an agent, virtual agent, QR code, uniform resource locator (URL) or link, or the like), search logic 120 may use personal identifiable information in the authentication request, along with the identified service provider to identify a user profile associated with both the user device and/or user and the identified service provider (e.g., referred to as the primary user profile). Search logic 120 may then iteratively identify one or more other user profiles associated with the same user device and/or user that correspond to other service providers (e.g., service providers that may be unaffiliated with the identified service provider) using the authentication request and the primary user profile. Alternatively, or additionally, search logic may use personal identifiable information (e.g., a user identifier, demographic information, a communication address, social security number, etc.) to identify one or more user profiles. Search logic 120 may assign the first user profile identified of the one or more user profiles as the primary user profile.

In some instances, search logic 120 may use one or more machine-learning models 128 to identify user profiles that correspond to same user device and/or user. For example, some user profiles may be established with slightly different data or data formats making a direct comparison difficult or impossible. A first user profile may identify a user by first name, last name while a second user profile may identify a user by middle name, last name making the second user profile appear unrelated to the first user profile despite being associated with a same user. ML models 128 may be trained to identify relationships within the user profiles and generate predictions that two or more user profiles are related by a same user device and/or user.

ML models 128 may include machine-learning algorithms such as, but are not limited to, k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, metalearning, reinforcement learning, deep learning, and other such algorithms and/or methods.

In some instances, the machine-learning model may be trained using training data received and/or derived from the user profiles (e.g., user profiles 124 and/or user profiles access from service providers 148), from historical sessions (e.g., involving the user device and/or the user thereof, involving other user devices and/or other users thereof, and/or the like), from interactions with an agent or virtual agent, and/or the like. In some instances, the training data or portions thereof may be manually generated. In some instances, the training data or portions thereof may be generated procedurally (e.g., automatically) using random number generators, hash functions, etc. and historical authentications performed by authentication system 104. For example, historical authentications may be analyzed to determine a range of features that may be included in an authentication process. The historical authentication data may be used to define, for each feature, a range of possible values for that feature based on observed values of that data type. A random number generator, for example, may then be used to generate a fake historical session by pseudo randomly selecting features to include in a simulated historical authentication as well as the values for each feature to be included. For some types of learning such as supervised learning, the training data can be labeled as corresponding to particular user profiles, particular user device and/or users, etc. The machine-learning model can be trained using supervised training, supervised training, semi-supervised training, reinforcement training, combinations thereof, or the like.

For example, the machine-learning model may be trained using transfer learning. Transfer learning may initially train a machine-learning model to solve a particular task as the starting point for training the machine-learning model to perform different task. Transfer learning can be useful when the second task is somewhat similar to the first task, or when there is limited training data available for the second task. For example, a machine-learning model initially trained to identify user profiles associated with a same user or user device can be further trained to predict authenticate a user device and/or user associated with a particular user profile. In some instances, the machine-learning models may access a pre-trained model and “fine-tune” the pre-trained model by training it on a second training dataset. The second training dataset can include training data that is labeled as corresponding to a particular user profile. To further fine-tune the machine-learning model, the machine-learning model may be reconfigured to include additional hidden and/or output layers to predict an association between two or more user profiles. In some instances, fine-tuning the pre-trained model includes unfreezing some of the layers of the pre-trained model and training them on the new training dataset. The number of layers that are unfrozen can depend on the size of the new dataset and how similar it is to the original dataset. For example, the fine-tuning of the machine-learning model can include freezing the weights of the machine-learning model, to train the machine-learning model to generate an authentication prediction (e.g., a likelihood that the user device and/or the user thereof is the same user device and/or the same user that facilitated generation of the user profile). Then, the weights can be unfrozen such that the machine-learning model can be trained to improve accuracy of the classification.

Authentication subsystem 116 may store an identification of the one or more user profiles associated with the same user device or user as determined by search logic and/or ML models 128 in user profiles 124. In some instances, authentication subsystem 116 may store, in each user profile, a list of identifiers corresponding to other user profiles associated with the same user device and/or user as the user profile.

Authentication processor 132 select and execute one or more authentication processes to authenticate the user device and/or the user associated with the authentication request. Authentication processor 132 may receive an identification of the one or more identified of user profiles associated with authentication request and an identification of the primary user profile. If received with the authentication request, the authentication processors 132 may also receive an identification of the operation to be executed in association with a user profile. Authentication processor 132 may assign a security level value to each operation (e.g., action, function, process, instructions, etc.) that can be executed through authentication system 104. The security level value corresponds to a threshold confidence that the user device and/or user corresponds to the same user device or user of the user profiles. Different authentication processes provide different confidence that user device and/or user is the same user as the user device or user of the user profiles. For example, requesting verification of personal identifiable information associated with a user profile may provide some confidence that the user device and/or user corresponds to the same user device or user of the user profiles, while transmitting a token or code to a device of a user profile and requesting the user device and/or the user provide the token or code may provide a higher degree of confidence that the user device and/or user corresponds to the same user device or user of the user profiles. The authentication process may select one or more authentication processes based on the security level of the operation to be executed (if received). If authentication processor 132 does not receive an identification of the operation, then authentication processor 132 may select one or more authentication processes based on the primary user profile, a particular user profile of the one or more user profiles (e.g., the user profile associated with highest security requirement, the user profile associated with lowest security requirement, a random user profile, etc.), the one or more user profiles, and/or the like. In some instances, the authentication processor 132 may request an identification of an operation from the user device and/or the user.

Examples of authentication processes include, but are not limited to, using the personal identifiable information (e.g., information received during initiation of the session or requested after establishing the session, etc.), a username and password, a token (e.g., previously provided by the computing device, a service provider associated with the action or the primary user profile or one or more other user profiles, or the like), a direct to device process (D2D) (e.g., where the authentication system may transmit a code or link to the user device or to a device associated with the primary user profile or another user profile of the identified user profiles), TrustStamp (e.g., one or more images of a physical identifier of the user), or other information.

Once authenticated, authentication processor 132 may transmit a communication to dynamic interfaces 136. Dynamic interfaces 136 may generate graphical user interfaces (GUIs), application programming interfaces (APIs), network interfaces, hardware interfaces (e.g., input/output interfaces, etc.) on demand to enable communications between authentication system 104 and user devices (e.g., computing device and mobile device, etc.) and service providers 148. For example, upon receiving an indication that the user device and/or the user is authenticated, dynamic interfaces 136 may generate a graphical user interface accessible to the user device with a presentation of the one or more user profiles. The primary user profile may be presented in a prioritized position (e.g., as the first user profile to be presented, on top of the one or more user profiles, on the bottom of the one or more user profiles, etc.). The user interface may include current information, real time information, historical information, and/or the like associated with the one or more user profiles. The user device may transmit commands to traverse the user interface (e.g., selecting a particular user profile, selecting one or more operations to execute with respect to a selected user profile, etc.). For example, selecting a user profile may cause dynamic interfaces 136 to generate a modified user interface that features the selected user profile over a larger portion of the user interface. The modified user interface may include additional information associated with the user profile. In some instances, dynamic interfaces 136 may customize user interfaces based on at least one previous instance the user device and/or user access the authentication system (and/or the particular service provider associated with at least one user profile of the one or more user profiles). For example, dynamic interfaces 136 may omit a presentation of operations that have a low likelihood of being requested by the user device and/or user, present operations in a particular order of the likelihood of being requested by the user device, present operations in a particular size or shape based on the likelihood of being requested by the user device, present operations in a particular color or shape based on the likelihood of being requested by the user device, present user profiles based on a likelihood of being selected by the user device and/or the user, combinations thereof, or the like. Dynamic interfaces 136 may modify the user interface to increase a rate in which the user interface can operated (e.g., by applying any of the above to the user interface).

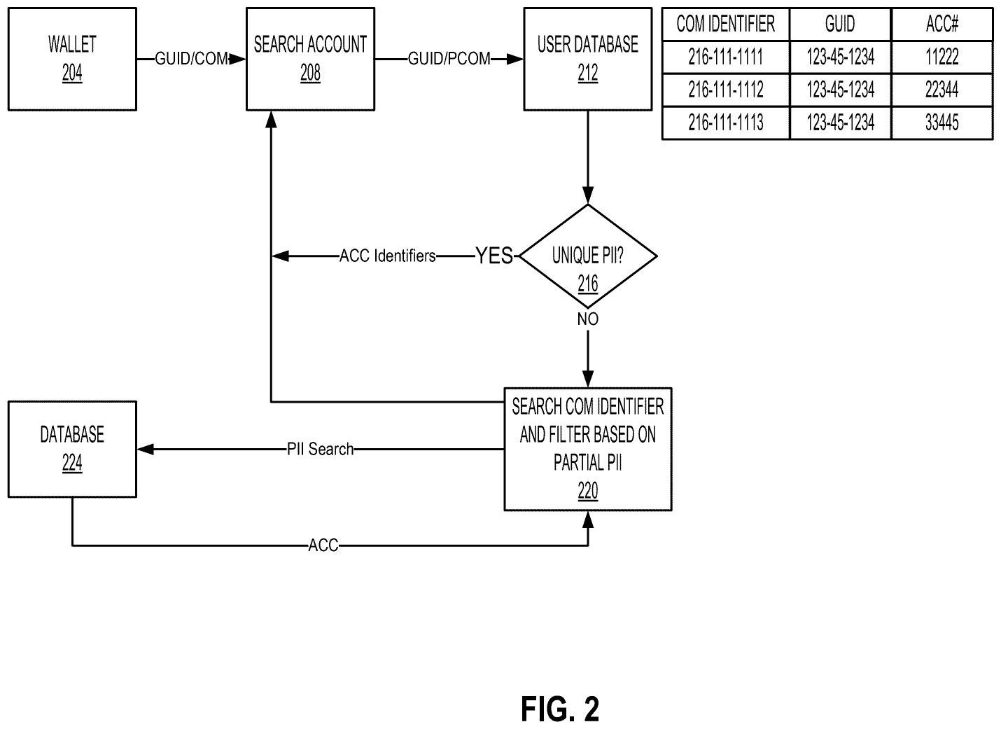

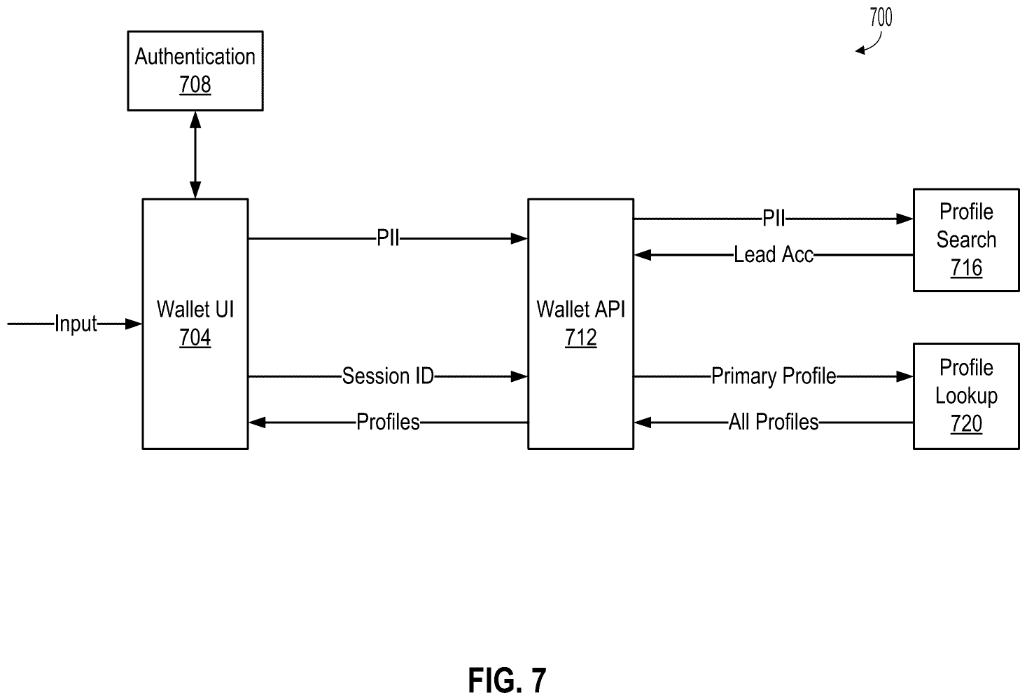

FIG. 2 illustrate a flowchart of an example process for identifying user profiles based on one or more identifiers according to aspects of the present disclosure. When a user device requests access to a user profile managed by an authentication system (e.g., such as authentication system 104), the authentication system may execute an identification process to identify one or more user profiles associated with that user device or the user thereof. The identification process may include two connected processes in which the first process attempts to identify a primary user profile associated with the user based on one or more identifiers. If the first process is unsuccessful, a second process may be used to identify the primary user profile using other information associated with the user such as personal identifiable information. The example process may be usable in various other process of the present disclosure such as, but not limited to, profile search 716 of FIG. 7.

The user device may access wallet 204, a web-based interface of the authentication system. Wallet 204 may include one or more interfaces (e.g., GUIs, APIs, etc.) that enable bidirectional communication between the authentication system and the user device. Since users may be associated with multiple user profiles, it may not be feasible for the user to remember different usernames and passwords for each user profile. The user device may access wallet 204 without using standard user credentials (e.g., username and password, etc.). Instead, wallet 204 may receive personal identifiable information associated with the user and use the personal identifiable information to identify the user interfaces associated with the user and authenticate the user device and/or user. The personal identifiable information may include, but is not limited to, a globally unique identifier (GUID), a communication address, information associated with the user device accessing wallet 204 (e.g., a device identifier, hardware and/or software installed on the device, network information such as an IP address or MAC address, etc.), demographic information, combinations thereof.

Search account 208 may receive the personal identifiable information associated with a primary user profile (e.g., a particular user profile of the user profiles associated with the user device and/or the user that may be selected by the user device and/or the user or identified based on a temporary channel over which the user device connected to wallet 204, etc.) and perform a user profile search using user database 212 (e.g., a database of user profile records). For example, search account 208 may execute a query (e.g., a structured query, or the like) using the personal identifiable information. User database 212 may store an identification of a user profile (e.g., ACC #) in association with a GUID (of known for that user profile) and/or a communication address (if known for that user profile) in tables, linked data structures, a ledger, or the like. User database 212 may output an identification of each of a set of user profiles that may be associated with the GUID and/or communication address. If the primary user profile cannot be found at search account 208 or user profiles associated with different users are identified, then the process proceeds to block 216 where the primary user profile may be identified the using other personal identifiable information.

For example, at block 216, it is determined whether the GUID is unique by matching personal identifiable information to the user profiles returned by user database 212. The personal identifiable information may be determined to be unique if the personal identifiable information only matches information from user profiles associated with the same user. If user database 212 returned user profiles that are each associated with the same user, then it may be determined that the personal identifiable information is unique and there are no more user profiles associated with the user. The process may return to search account 208. Search account 208 may then cause wallet 204 to present the set of user profiles via the web-based interface. If the user profiles returned by user profiles 124 include user profiles associated with two or more different users, than the personal identifiable information may not be unique and the process may continue to block 220 where the communication address and other personal identifiable information (e.g., such as, but not limited to personal identifiable information received by wallet 204, personal identifiable information obtained from the user profiles of the set of user profiles, and/or personal identifiable information requested from the user device and/or the user) to search database 224 for user profiles that correspond to the user device and/or the user. Database 224 may include user profiles, user profile records (similar to or the same as those stored in user database 212, service provider records, resource allocation records, etc. usable to identify the user profiles that may be associated with the user device and/or the user. Database 224 may return an identification of a second set of the user profiles associated with the user device and/or user to block 220. The second set of user profiles may be the same or different from the set of user profiles obtained from user database 212. The set of user profiles obtained from user database 212 may be combined with the second set of user profiles and output to search account 208 where it may be presented via the web-based interface.

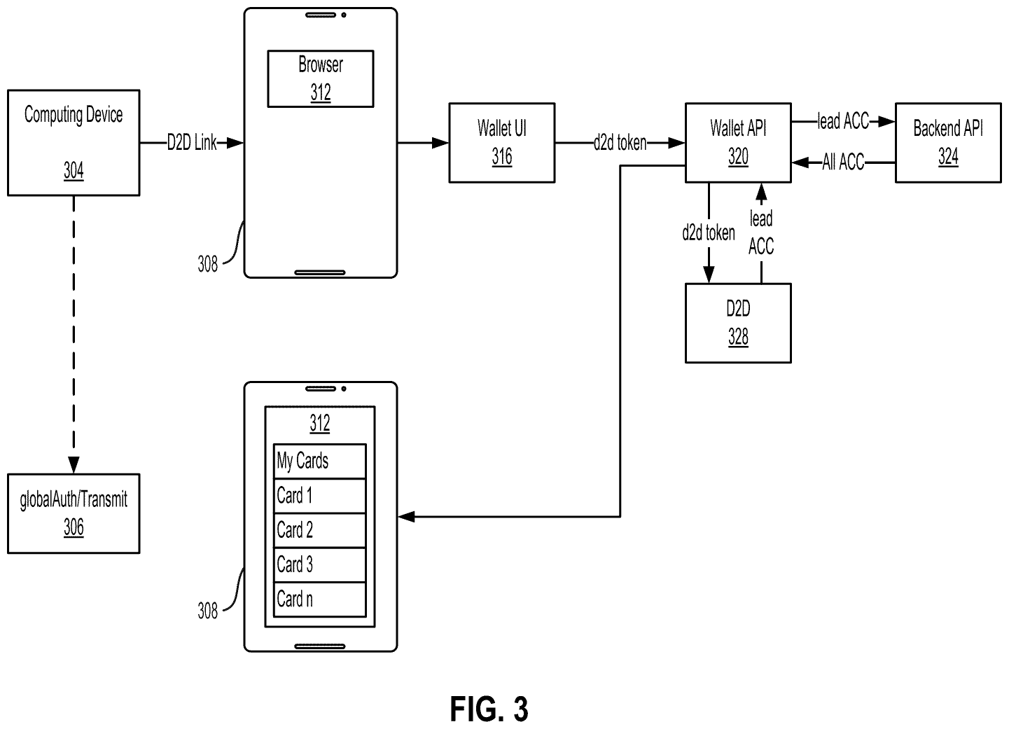

FIG. 3 illustrates a block diagram of an example user authentication system configured to identify and authenticate requests based one or more identifiers according to aspects of the present disclosure. A first user device (e.g., operated by a user) may connect with an agent or virtual agent (e.g., a software bot configured to communicate via text or audio via natural language communications that appear as human communications, etc.) over a telephone connection. The agent may operate computing device 304 to resolve requests received from the first user device. The first user device may transmit an identification of a user of the first user device and a user profile for which the user intends to request execution of an action. In some examples, the agent or virtual agent may perform a global authorization (e.g., globalAuth 306) may execute a multifactor authentication process that transmits a code to the first user device over a separate communication channel (e.g., email, text messaging, direct messaging, instant messaging, etc.) and requests that the first user device and/or the user provide the code back to the agent or virtual agent over the telephone connection. Alternatively, the agent or virtual agent may request a TrustStamp process (e.g., where the first user device is instructed to transmit an image of a physical identification such as a driver's license to the agent over a separate communication channel). Alternatively still, the agent or virtual agent may authenticate the first user device via Transmit authentication. If the first user device is authenticated then a session may be established that authorized the first user device to perform certain actions for a predetermined time interval (e.g., an hour, a day, n days, etc.). Once authenticated, computing device 304 may execute an action associated with the particular user profile.

In other examples, computing device 304 may authenticate the user using a d2d authentication process. The d2d process may include transmitting a link to second user device 308 (e.g., different from the first user device or the same user device as the first user device) identified by the primary user profile. Second user device 308 may be a mobile device such as a smartphone or tablet that operates a web-based interface such as browser 312. The link may provision second user device 308 with a d2d token that may be used to authenticate subsequent communications from second user device 308. The link may also initiate wallet interface 316, which may be displayed via browser 312. Wallet interface 316 may transmit the d2d token to wallet API 320 which may execute one or more function calls to authenticate second user device 308 relative to the primary user profile, load data from the primary user profile, and identify one or more additional user profiles. For instance, wallet API 320 may transmit the d2d token and an identification of the primary user profile to D2D 328. D2D may authenticate the d2d token and return information associated with the user and the primary user profile such as, but not limited to, first name, last name, mobile device telephone number, social security number, date of birth, zip code, authentication system identifier, primary user profile data, an identification of the service provider associated with the primary user profile, primary account number (PAN) of the primary user profile, account history, combinations thereof, or the like.

Wallet API 320 may execute a function call to backend API with an identification of the primary user profile and/or the information returned from D2D 328. Backend API 324 may execute internal queries using identification of the primary user profile and/or the information returned from D2D 328 to identify one or more additional user profiles. Backend API 324 may return the one or more additional user profiles to wallet API 320. Wallet API 320 may then generate and present a new interface via browser 312 of second user device 308. The new interface may include a presentation of the primary user profile and the one or more additional user profiles. Since second user device 308 is authenticated using the primary user profile and the profile is associated with the one or more additional user profiles, second user device 308 and the user may be authenticated to access information and perform actions associated with any of the primary user profile and the one or more additional user profiles.

Second user device 308 may execute an action via the new interface. For example, second user device 308 may select card 1 (e.g., a first user profile) and provision a secure environment within second user device 308 with a token usable to access a resource associated with card 1. For example, user device 308 may provision an electronic wallet (e.g., Apple Wallet, Google Wallet, etc.) with a token. Second user device 308 may execute a transaction using the token via NFC, or the like. In some instances, the processes of FIG. 3 may be performed when physical access to card 1 is unavailable. For instance, when a user is physically located near a terminal device without card 1 being present. The user may provision a token representing card 1 via processes of FIG. 3 and execute transactions without having access to card 1.

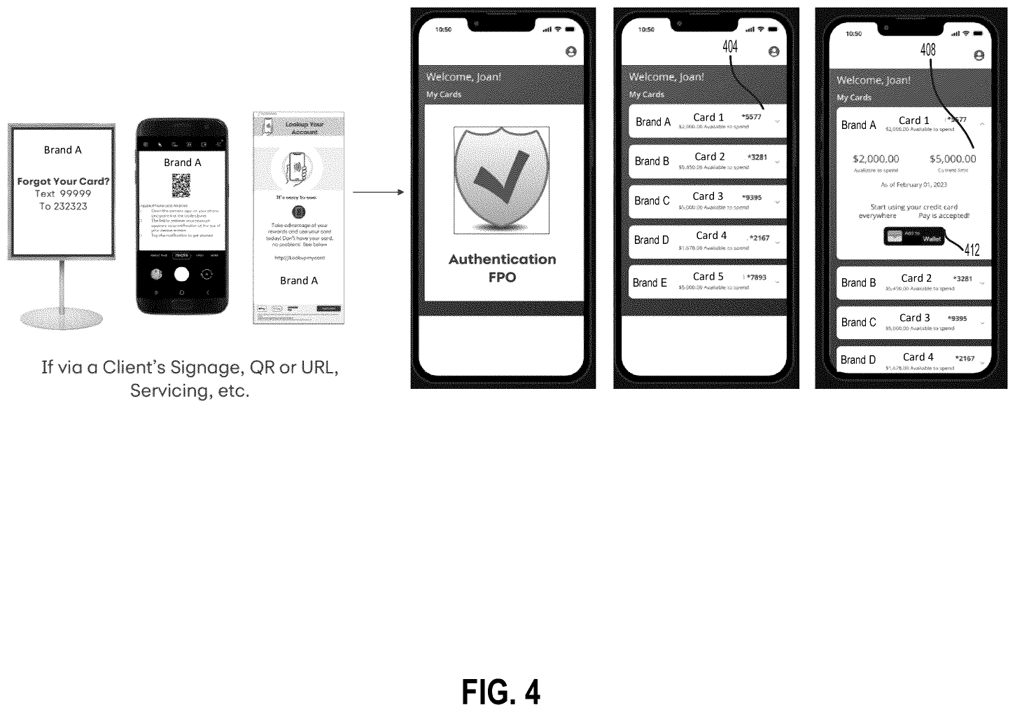

FIG. 4 illustrate example user interfaces enabling execution of various actions associated user profiles based on user authentication according to aspects of the present disclosure. A user device may access the authentication system from different channels. In some examples, a user may access the authentication system from a web browser, via an agent, via a virtual agent, or the like. In other examples, the user may access the authentication system via an executable object provided by a service provider for which the user has an established user profile. For example, a service provider may present an object (e.g., a QR code, barcode, URL, etc.) via a sign or the like. The user may capture an image of the object using a user device causing the user device to execute the object. Executing the object may facilitate presentation of instructions for linking the user profile of the user to one or more additional user profiles associated with the user and managed by the authentication system.

The authentication system may assign the user profile as a primary user profile (for this session) and use the primary user profile to identify the one or more additional user profiles (as previously described in connection to FIG. 2 and FIG. 3). Once identified, the authentication system may present a user interface with primary user profile 404 (e.g., on top) and the one or more additional user profiles. The user may interact with the user interface by selecting a user profile (e.g., such as primary user profile 404 as shown) to display additional information associated with the user profile (e.g., 408) and one or more actions that can be executed in association with the selected user profile (e.g., 412). Examples of actions that may be executed, include, but are not limited to provisioning a secure environment (e.g., an electronic wallet, etc.) within a user device with token associated with a resource of a user profile, request a status of a user profile or a resource associated with a user profile, request an increase in resources associated with a user profile, request a new resource associated with a user profile, provide resources, access a virtual assistant associated with a particular user profile, access a virtual agent associated with the one or more user profiles, access an agent (e.g., a customer service representative) associated with a particular user profile, access an agent associated with the authentication system, combinations thereof, or the like.

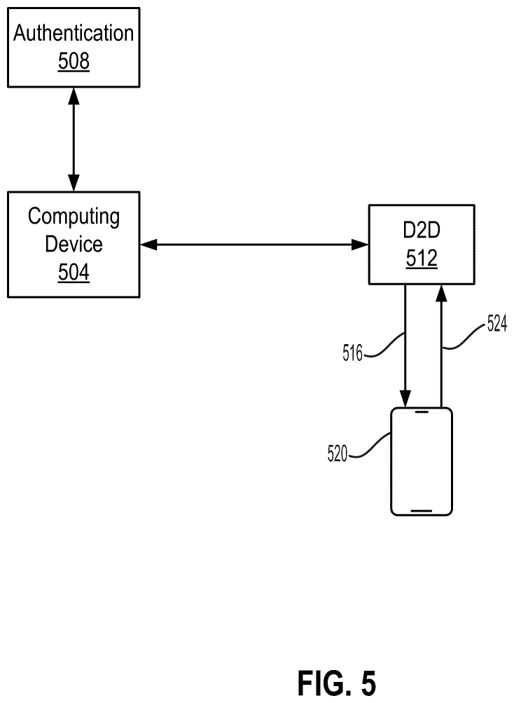

FIG. 5 illustrate a block diagram of a D2D process for authenticating a device according illustrate to aspects of the present disclosure. Computing device 504 may be a device associated with a service provider, which may be configured to provide services to a user or user device (e.g., such as to user device 520, etc.). A user may connect to computing device 504 to request services or information associated with services that are provided by the service provider relative to that user (e.g., such as products or services provided by the service provider, a user profile associated with the user, etc.). Computing device 504 may be operated by an agent, an automated service (e.g., such as software service configured to communicate with a user using natural language communications that simulate an agent), or the like. Computing device 504 may execute a D2D process to enable a credential-less authentication process for the user to enable authenticating the user without requiring access credentials such as a username and password, pin, or other coded information.

For example, computing device 504 may transmit information associated with the user and/or the connection with the user such as, but not limited to, a name of the user, the phone number associated with the connection to computing device 504 (if the user is using a telephonic connection), an IP address, combinations thereof, or the like. Authentication 508 may use the information to determine if the D2D process is sufficient to authenticate the user or if a more secure authentication process is required. For example, if the user has recently connected to computing device 504 (or to a device associated with computing device 504) and was authenticated during the previous connection, then there it likely that the user is authentic (e.g., that the user is the person that the user says they are and not impersonating another user, etc.) and a D2D process can be used to authenticate the user. If the user has not recently connected to computing device 504 (or to a device associated with computing device 504), then a more secure authentication process should be executed to authenticate the user. If authentication 508 determines that the likelihood that the user is authentic is less than a threshold, then computing device 504 may be directed to request additional information from the user that can be compared to the information identified by authentication 508. If the information does not match, computing device 504 may terminate the D2D authentication process and execute a different authentication process (e.g., such as a credential-based authentication, TrustStamp, etc.).

If authentication 508 determines that the likelihood that the user is authentic is less than a threshold, the process may continue by transmitting a request to D2D 512. D2D 512 may generate link (e.g., a uniform resource locator (URL)) with an embedded token. The link may be transmitted to over a first communication channel 516 (e.g., short messaging service or text messaging, telephone, email, direct messaging, push notification, or any other communication channel receivable by user device 520). User device 520 may transmit a communication to D2D using the URL (e.g., by execute the link, etc.) over a second communication channel 524 (e.g., a web-based communication channel in this example). By executing the link, D2D can authenticate that user device 520 is associate with the user connected to computing device 504, which may authenticate the user. D2D 512 may transmit the reply with the link to computing device 504 indicating the user is authenticated. In some instances, second communication channel 524 may a non-web-based communication channel (e.g., such as when user device 520 lacks the capability to execute the link, etc.). D2D may generate a communication address (e.g., a phone number, memory address, mailbox, etc.,) and communicate the communication address via first communication channel 516. User device 520 may receive the communication address and transmit a communication response to D2D 512 using the communication address to authenticate user device 520. In other instances, first communication channel 516 and second communication channel 524 may be a same communication channel.

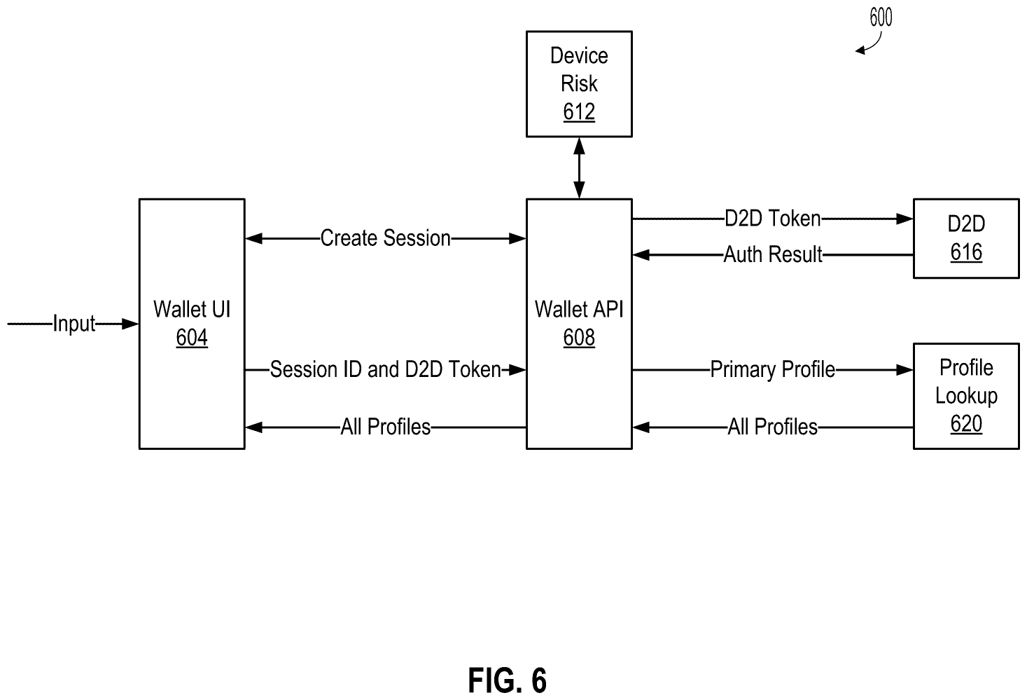

FIG. 6 illustrates a block diagram of a process for identifying user records using D2D according to aspects of the present disclosure. Process 600 may include a credential-less authentication process to enable a user to access and manage one or more user profiles associated with the user. Process 600 may be initiated when an input hook is executed causing a user device to load wallet UI 604. The input hook may be a barcode, QR code, link provided by an agent or automated service, URL, and/or the like. The user device may connect to wallet UI 604 via a web browser causing the wallet user interface to be presented by the user device. Wallet UI 604 may begin identifying and authenticating the user device to enable the user device to access one or more user profiles associated with the user via single user interface. Wallet UI 604 may generate a communication to wallet API creating a new session. The communication may include information associated with the user device and/or the user thereof received or derived by wallet UI 604 such as, but not limited to, such as, but not limited to, a name of the user, the phone number associated with the connection to computing device 504 (if the user is using a telephonic connection), an IP address, combinations thereof, or the like. In some instances, the information associated with the user device and/or the user thereof may be derived based on the connection established with wallet UI 604. For example, if the user connects to an agent associated with a service provider, the agent may transmit a link via text message to the phone number of the mobile device operated by the user, when the user executes the link, the phone number may be transmitted to wallet UI 604 as an identifier of the user.

Wallet API 608 may receive the create session request and generate a session ID. Wallet API 608 may then pass the information associated with the user to device risk 612 to determine an authentication process that can authenticate the user. Process 600 may include a credential-less authentication of users based on a risk assessment of the user when a new session is created. A user that frequently accesses a service provider that initiated access to wallet UI 604 using a same mobile device (or computing device), may be more likely to be an authentic user than a user that has not accessed the service provider in some time. Device risk 612 may define a risk score for the user based on characteristics of the connection with the user (e.g., user identifier, telephone number, IP address, user profile accessed, user profile information, etc.) and historical connection information (e.g., previous instances in which the user connected to the service provider and/or wallet UI 604). If the risk value is less than a threshold, then device risk 612 may indicate that a D2D process may be executed. If the risk value is greater than a threshold, then device risk 612 may restart the authentication process using a more secure authentication process should be executed (e.g., access credentials such as a username and password, TrustStamp, etc.) and/or may restart the authentication process.

When device risk 612 determines that the risk value is less than the threshold, Wallet API 608 may be directed to generate a D2D token and pass the D2D token to D2D 616 to execute a D2D process (e.g., as previously described in connection to FIG. 5). D2D may authenticate the user may transmitting URL with the D2D token embedded therein to the user device. User device may execute the link providing an indication that the user device is being operated by the user. The D2D token may be passed during various communications between wallet UI 604 and wallet API 608 during the session as proof that the user device has been authenticated. D2D 616 may transmit an authentication result to wallet API 608, which may pass the session ID to wallet UI 604.

Wallet UI 604 may then identify the user profiles associated with the user. Wallet UI 604 may transmit the session ID and the D2D token to wallet API 608 requesting information associated with each user profile associated with the user. Wallet API 608 may determine that the user device has been authenticated using the D2D token, then use the session ID to look up the primary user profile (e.g., Primary Acc, etc.) associated with the user device. For example, the primary user profile may correspond to the user profile associated with the service provider that connected the user device to wallet UI 604. Wallet API 608 may transmit an identification of the primary user profile to profile lookup 620. Profile lookup 620 may identify each user profile associated with the primary user profile. In some instances, profile lookup 620 may store, in each user profile, an identification of a set of user profiles associated with a same user as that user profile. In other instances, profile lookup 620 may use information in the primary user profile to identify the set of user profiles associated with the same user as the primary user profile. Profile lookup 620 may transmit an identification of the set of user profiles that correspond to the user device to wallet API 608, which may pass the set of user profiles to wallet UI 604. Wallet UI 604 may then render a user interface enabling the user to access information and/or services associated with each user profile.

The user interface of wallet UI 604 may enable the user device execute functions associated with any of the user profiles (e.g., the primary user profile and/or the set of user profiles). For instance, the user device may store an object (e.g., a virtual card, etc.) within an electronic wallet of the user device, provision a virtual card associated with a user profile, maintain a virtual card associated with a user profile, generate and/or access tokens associated with a card (e.g., such as a card on file token, etc.), generate temporary shopping passes, execute transactions (e.g., without physical access to a card of a user profile), combinations thereof, or the like.

FIG. 7 illustrates a block diagram of a process for identifying user records using PII according to aspects of the present disclosure. Process 700 may be initiated when an input hook is executed causing a user device to load wallet UI 704. The input hook may be a barcode, QR code, a link provided by an agent or automated service, a URL, and/or the like. The user device may connect to wallet UI 704 via a web browser causing the wallet user interface to be presented by the user device. Wallet UI 704 may begin identifying and authenticating the user device to enable the user thereof to access one or more user profiles associated with the user via a single user interface. If wallet UI 704 determines that there is a user profile associated with the user, then process 600 of FIG. 6 may be executed to authenticate the user and generate a user interface with the user profiles associated with the user. If wallet UI 704 cannot identify a user profile associated with the user, then process 700 may be executed to authenticate the user and generate a user interface with the user profiles associated with the user.

Wallet UI 704 may then pass information associated with the user to authentication 708 to determine an authentication process that can authenticate the user device. The information associated with the user may include, but is not limited to, a name of the user, a phone number associated with the user device, an IP address of the user device, combinations thereof, or the like. In some instances, the information associated with the user device and/or the user thereof may be derived based on the connection established with wallet UI 704. For example, if the user connects to an agent associated with a service provider, the agent may transmit a link via text message to the phone number of the mobile device operated by the user, when the user executes the link, the phone number may be transmitted to wallet UI 704 as an identifier of the user.

Process 700 may include a credential-less authentication of users based on a risk assessment of the user when a new session is created. A user that frequently accesses a service provider that initiated access to wallet UI 704 using a same mobile device (or computing device), may be more likely to be an authentic user than a user that has not accessed the service provider in some time. Authentication 708 may define a risk score for the user based on characteristics of the connection with the user (e.g., user identifier, telephone number, IP address, user profile accessed, user profile information, etc.) and historical connection information (e.g., previous instances in which the user connected to the service provider and/or wallet UI 704). If the risk value is less than a threshold, then authentication 708 may execute a D2D process (e.g., as previously described in connection with FIG. 5). If the risk value is greater than a threshold, then authentication 708 may restart the authentication process using a more secure authentication process should be executed (e.g., access credentials such as a username and password, TrustStamp, etc.) and/or may restart the authentication process.

Once the user device is authenticated, wallet UI 704 may transmit a communication requesting a primary user profile associated with the user to Wallet API 712. The request may include personal identifiable information (PII) associated with the user. Wallet API 712 may execute a call to profile search 716 to identify the primary user interface associated with the PII. In some examples, profile search 716 may execute the example process described in FIG. 2. If profile search returns more than one primary user profile is identified, Wallet API 712 may determine which primary user profile returned by profile search 716 will be used for further processing of process 700. Alternatively, the one or more primary user profiles may be return toed wallet UI 704 and wallet UI 704 may select a user profile from the one or more primary user profiles by requesting additional information from the user device and comparing it to the one or more primary user profiles.

Wallet API 712 may return an identification of the primary user profile to wallet UI 704. Wallet UI 704 may generate a session ID based on the primary user profile and transmit a request user profile request to wallet API. The user profile request may include the session ID and a request for an identification of each user profile that is associated with a same user as the primary user profile. Wallet API 712 may transmit an identification of the primary user profile to profile lookup 720. Profile lookup 720 may identify each user profile associated with the primary user profile. In some instances, profile lookup 720 may store, in each user profile, an identification of a set of user profiles associated with a same user as that user profile. In other instances, profile lookup 720 may use information in the primary user profile to identify the set of user profiles associated with the same user as the primary user profile. Profile lookup 720 may transmit an identification of the set of user profiles that correspond to the user device to wallet API 712, which may pass the identification of the set of user profiles to wallet UI 704. Wallet UI 704 may then render a user interface enabling the user to access information and/or services associated with each user profile.

The user interface of wallet UI 704 may enable the user device execute functions associated with any of the user profiles (e.g., the primary user profile and/or the set of user profiles). For instance, the user device may store an object (e.g., a virtual card, etc.) within an electronic wallet of the user device, provision a virtual card associated with a user profile, maintain a virtual card associated with a user profile, generate and/or access tokens associated with a card (e.g., such as a card on file token, etc.), generate temporary shopping passes, execute transactions (e.g., without physical access to a card of a user profile), combinations thereof, or the like.

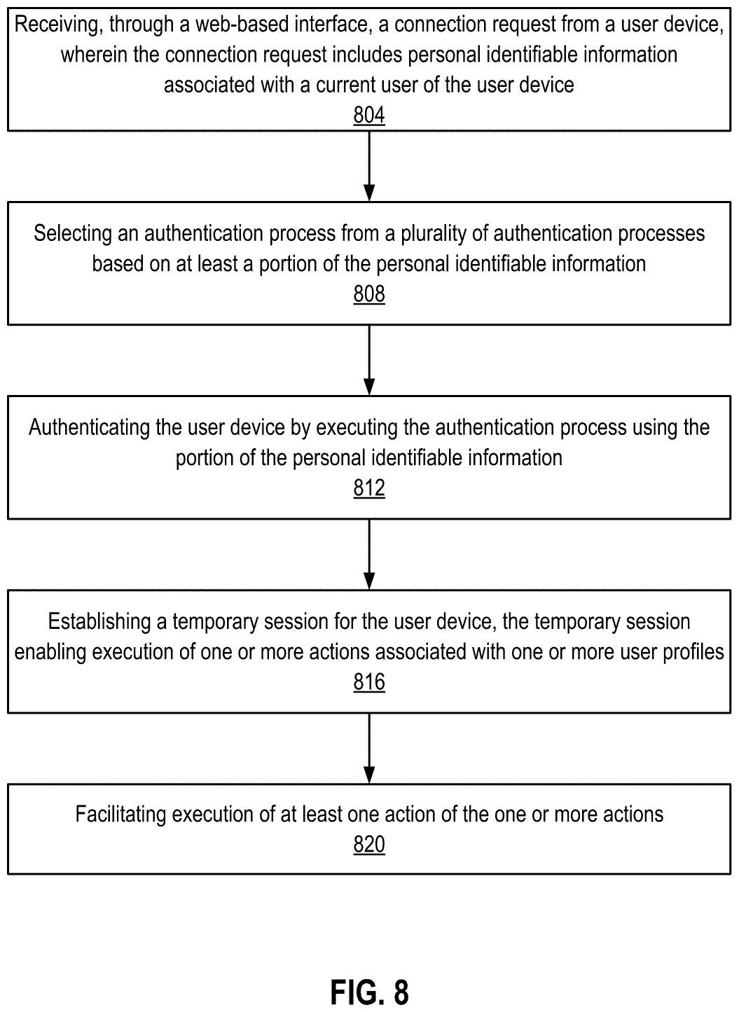

FIG. 8 illustrates a flowchart of an example process authenticating users across disparate systems according to aspects of the present disclosure. At block 804, a computing device may receive a connection request from a user device through a web-based interface. The computing device may be an authentication system (e.g., such as authentication system 104 of FIG. 1), a component of the authentication system, a webserver, a device in communication with the authentication system, and/or the like. In some instances, the user device may access the web-based interface through one or more temporary channels such as, but not limited to, instant messaging, direct messaging, telephony, etc. associated with an agent and/or virtual agent (e.g., large language model, natural language model, other machine-learning models, etc.). In other instances, the user device may access the web-based interface via a web browser, an executable link (e.g., provided via text messaging, instant messaging, email, etc.), a QR code, and/or the like. The connection request may include personal identifiable information associated with a current user of the user device. For example, the personal identifiable information may include, but is not limited to, a name of the user, a globally unique identifier (e.g., a social security number, an identifier previously assigned by the computing device to the user and/or the user device, etc.), a communication address (e.g., phone number, Internet Protocol (IP) or Media Access Control (MAC) address, email address, etc.), a physical address associated with the user (e.g., a mailing address, etc.), an identification of one or more user profiles associated with the user, an identification of data stored in the one or more user profiles, and/or the like.

The computing device may use the personal identifiable information to identify one or more user profiles associated with the user device and/or the user. In some instances, the computing device may first identify a primary user profile. The primary user profile may be a user profile associated with how the user device and/or the user established the connection request with the computing device. For example, a QR code may be provided by a service provider with which the user has a user profile. The QR may include an identification of the service provider that provided the QR code and/or the user profile of the service provider such that executing the QR may indicate, to the computing device, the service provider and/or the user profile associated with the user device and/or the user. Alternatively, the computing device may request an identification of a primary user profile from the user device. Alternatively still, the computing device may perform a search to identify the user profiles associated with the user device and/or the user (e.g., using the personal identifiable information, additional personal identifiable information requested from the user device and/or the user, etc. and search logic such as, but not limited to, structured queries, database tables, a machine-learning model, etc.).

After identifying a first user profile, the computing device may confirm that the first user profile corresponds to the user device and/or the user by for example, transmitting a code to a device identified in the user profile and requesting the code from the user device. Alternatively, the computing device may confirm that the first user profile corresponds to the user device and/or the user by requesting the information that corresponds to information stored in the first user profile (e.g., personal identifiable information, a date in which the first user profile was established, a date in which the first user profile was last accessed, an identifier of the first user profile, etc.). If the first user profile is confirmed to be associated with the user device and/or the user, the computing device may determine that the first user profile is the primary user profile for this session between the user device and the computing device. If the first user profile is not confirmed to be associated with the user device and/or the user, then the computing device may identify a next user profile and confirm that user profile. The process may continue until a user profile can be confirmed as being associated with the user device and/or the user or until there are no more user profiles that match the personal identifiable information. If there are no more user profiles that match the personal identifiable information and that can be confirmed as being associated with the user device and/or the user device, then the computing device may store the personal identifiable information and information associated with the user device (e.g., a device identifier, hardware installed on the device, software installed on the device, an IP address of the device, a MAC address of the device, an communication address of the device such as a phone number or the like, combinations thereof, or the like) in case it is determined the user of the user device fraudulently attempted to access user profiles associated with another user.

The computing device may use the primary user profile to identify one or more other user profiles associated with the user. Each user profile may be associated with a service provider that established the user profile. In some examples, one or more user profiles may be associated with a same service provider as another user profile. In some instances, the primary user profile may store an identification of the one or more other user profiles. In other instances, the computing device may use the personal identifiable information as well as information in the primary user profile to identify the one or more other user profiles. Identifying the one or more other user profiles may include database tables, structured queries, machine-learning models, user input (e.g., from the user of the user device, etc.), combinations thereof, and the like.

At block 808, the computing device may select an authentication process from a plurality of authentication processes based on at least a portion of the personal identifiable information, the primary user profile, the one or more other user profiles, an action to be executed in association with a user profile, combinations thereof, or the like. For example, the authentication process may be selected based on a security level identified by the computing device, the primary user profile, the one or more other user profiles, a service provider associated with the primary user profile or the one or more other user profiles, an action to be executed in association with a user profile, etc. Examples of authentication processes include, but are not limited to, using the personal identifiable information (e.g., information received during initiation of the session or requested after establishing the session, etc.), a username and password, a token (e.g., previously provided by the computing device, a service provider associated with the action or the primary user profile or one or more other user profiles, or the like), a direct to device process (D2D) (e.g., where the authentication system may transmit a code or link to the user device or to a device associated with the primary user profile or another user profile of the identified user profiles), TrustStamp (e.g., one or more images of a physical identifier of the user), or other information. In some instances, the authentication processes may be defined as a hierarchy based on a security level associated with the authentication process. The security level may be indicative of a confidence that the authentication process accurately authenticates a user device and/or the user thereof. For example, authenticating the user device and/or the user thereof using personal identifiable information (e.g., by comparing the personal identifiable information to corresponding information of the identified user profiles) may be less secure than a D2D process, and a D2D process may be less secure than a TrustStamp process.

At block 812, the computing device may authenticate the user device and/or the user thereof by executing the selected authentication process.

At block 816, the computing device may establish a temporary session for the user device in response to authenticating the user device and/or the user thereof. The temporary session may enable execution of one or more actions associated with one or more user profiles. The computing device may receive input identifying an action to be executed and a particular user profile for which the action is to be executed against. Examples of actions include, but are not limited to, provisioning a secure environment (e.g., a wallet, etc.) of the user device with token associated with a resource of a user profile or a virtual token associated with the user profile, request a status of a user profile or a resource associated with a user profile, request an increase in resources associated with a user profile, request a new resource associated with a user profile, provide resources, access a virtual assistant associated with a particular user profile, access a virtual agent associated with the one or more user profiles, access an agent (e.g., a customer service representative) associated with a particular user profile, access an agent associated with the authentication system, combinations thereof, or the like. For example, a user device may connect to the authentication system and, upon being authenticated, provision a token (e.g., a live token corresponding to a resource, a single-use token corresponding to a resource, a virtual token corresponding to a resource, etc.) into a secure environment within the user device. Once provisioned, the user device may access the resource at a terminal device using the token and a secured communication process between the user device and the terminal device (e.g., NFC, or the like). The user can access a plurality of user profiles associated with the user at once and execute operations associated with individual user profiles from an interface of the authentication system without individually authenticating the user for each user profile or using client-side processing (e.g., a native application, etc.).

At block 820, the computing device may then facilitate execution of at least one action of the one or more actions. In some instances, facilitating execution of an action may include provisioning a secure environment within the user device with a token associated with a resource of the particular user profile or a virtual token associated with the resource of the particular user profile. Once provisioned, the user device may access the resource using the token or virtual token via NFC. By provision the secure environment via the computing device, a user may access the resource associated with the user profile without having physical access of the physical card associated with the user profile. In other instances, facilitating execution of an action may include executing the action by the computing device. In still yet other instances, facilitating execution of an action may include transmitting a communication to a service provider associated with the particular user profile causing the service provider to execute the action on behalf of the computing device. The service provider may transmit a response updating the user profile based on the execution of the action.

Once an action is executed, the computing device may request a selection of a subsequent action. If the subsequent action depends on a higher security level than the executed authentication processes, then the computing device may execute a new authentication process selected based on the selected subsequent action. If the subsequent action depends on a same or lower security level, then the computing device may execute the action. If no subsequent action is selected, then the session with the computing device may terminate. Upon termination, the user device may be returned to the temporary channel. For example, if the temporary channel is a telephony channel, then the user device may be reconnected to the temporary channel enabling the user device to continue communicating with an agent, virtual agent, etc.

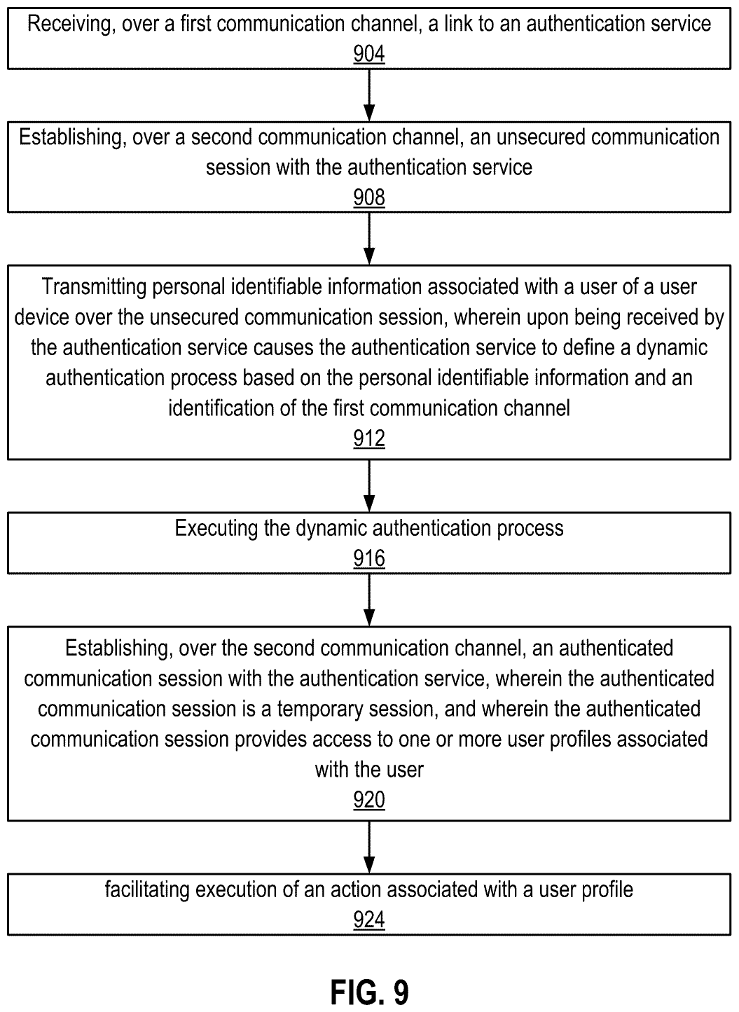

FIG. 9 illustrates a flowchart of an example process for authenticating user devices over unsecured communication channels according to aspects of the present disclosure. At block 904, a user device may receive a link to an authentication system (e.g., such as authentication system 104 of FIG. 1) through a first communication channel. The first communication channel may be a temporary or persistent communication channel such as, but not limited to, a web-based interface (e.g., a webpage, web application, application configured to communicate using web-based protocols, etc.), instant messaging, direct messaging, telephony, email, etc. For example, the user device may be connected to an agent or virtual agent (e.g., large language model, natural language model, other machine-learning models, communication bot, etc.) over a communication channel. The agent and/or virtual agent may provide the link to the user device over the communication channel or another communication channel. In other words, the user device may receive the link over the connection with the agent or virtual agent or the user device may receive the link over a parallel communication channel. In another example, the user device may receive the link by accessing a code (e.g., barcode, quick response code, etc.) printed on a physical medium (e.g., a sign, etc.) or within a graphical interface, etc.

In some examples, the user device may receive the link in response to a request to execute an action associated with a user profile, which may be associated with the user of the user device. For instance, the user profile may be associated with a secured resource accessible by the user via physical card. If the physical card is not available to the user, then the user may be unable to access the secured resource. The user device may connect to an agent and/or virtual agent through the communication channel to request temporary access to the secured resource without the physical card. The agent and/or virtual agent may then transmit the link to the user device. In some instances, the agent or virtual agent may request information from the user (e.g., such as personal identifiable information, user profile information, device information, etc.) to authenticate the user device and/or the user thereof.

Alternatively, the link may be accessible to the user device by being in physical proximity to the user device. For instance, the user device may access a code proximate to the user device using a camera and/or an input/output device. The user device may resolve the code into the link.

At block 908, the user device may establish an unsecured communication session with the authentication system. The user device may use the link to connect to the authentication system. The link may identify an address of the authentication system. Alternatively, the link may identify an address accessible by the authentication system. The second communication channel may be a web-based communication channel or an application (e.g., such as an application associated with the authentication system installed on the user device or accessible to the user device, etc.). In some examples, the link may be a uniform resource locator or be resolved into a uniform resource locator.

The authentication system may execute some security protocols to ensure that a connection with the user device is safe for the user device and/or the authentication system. Alternatively, or additionally, the authentication system may restrict access to particular features of the unsecured communication session to prevent unauthorized access to the user device and/or to the authentication system. For example, the authentication system may restrict execution of particular instructions or instruction sets (e.g., such as JavaScript instructions, etc.) to prevent code execution attacks or the like.

In some examples, the user device may provide an identification of a purpose or intent for establishing the unsecured communication session with the authentication system. For example, the user device may identify the action the action to be executed with respect to a user profile. Alternatively, or additionally the user device may identify information or type of information to be requested over the unsecured communication session.

At block 912, the user device may transmit personal identifiable information associated with a user of the user device over the unsecured communication session. The user device may transmit the personal identifiable information in response to a request for particular personal identifiable information from the authentication system. Alternatively, the user device may transmit the personal identifiable information without a request from the authentication system. The personal identifiable information may include, but is not limited to, a name of the user, a globally unique identifier (e.g., a social security number, an identifier previously assigned by the authentication system to the user and/or the user device, etc.), a communication address (e.g., phone number, Internet Protocol (IP) or Media Access Control (MAC) address, email address, etc.), a current or previous physical address associated with the user, an identification of one or more user profiles associated with the user, an identification of data stored in the one or more user profiles, combinations thereof, and/or the like.

In some examples, the authentication system may determine what personal identifiable information should be transmitted based on the unsecured status of the communication session. For example, the authentication system may not request highly sensitive personal identifiable information (e.g., such as globally unique identifiers, etc.) due to the unsecured nature of the communication session. Instead, the authentication system may request additional personal identifiable information that may identify the user of the user device. Alternatively, or additionally, the user device may determine what personal identifiable information to transmit based on the unsecured status of the communication session. For example, the user device may determine what personal identifiable information is safe to transmit over the unsecured communication session. Alternatively, or additionally, the user device may encrypt the personal identifiable information before transmitting the personal identifiable information to the authentication system.

The authentication system may receive the personal identifiable information. The authentication system may then define a dynamic authentication process based on the personal identifiable information and an identification of the first communication channel. The authentication system may define different authentication processes based on the information provided by the user and the first communication channel (e.g., the link itself and/or how the user device received the link). In some examples the authentication system may define weights for each type of personal identifiable information based on a degree in which a type of personal identifiable information can uniquely identify a particular user. In some instances, the weights may be further defined based on a likelihood that a type of personal identifiable information is provided by the user and not by someone personating the user. For example, a globally unique identifier (e.g., such as a social security number, etc.) is more likely to be provided by the user than an imposter because it may be less likely to be discoverable by the imposter. Such information would be assigned a high weight. On the other hand, an address or demographic information could be easily discoverable by an imposter and be assigned a low weight. In some examples, the authentication system may also weight additional factors such as, but not limited to, an evaluation of historical interactions with the user device and/or the user thereof, an evaluation of the personal identifiable information, the purpose or intent for establishing the connection with the authentication system, the first communication channel, and/or any other information. The authentication system may apply the weights to the received personal identifiable information to derive a first confidence of a unique identity of the user as well as a second confidence that the unique identity corresponds to the user and not an imposter. Alternatively, the authentication may derive a single confidence from the first confidence and the second confidence.

In some examples, the authentication system may also define the dynamic authentication process based on the first communication channel. For example, the first communication channel may be a secured channel in which the user device is connected to an agent and/or virtual agent that has partially or completely authenticated the user device and/or the user thereof. In those instances, the first confidence and/or the second confidence (or the overall confidence) may be adjusted based on the authentication applied by the first communication channel. In some instances, the first communication channel may be an unsecured communication channel that has provided the link to the user without requesting an identity of the user device and/or the user thereof or authenticating the user device and/or the user thereof. In those instances, the first confidence and/or the second confidence (or the overall confidence) may not be adjusted or be adjusted based on the lack of authentication applied by the first communication channel.

Examples of dynamic authentication processes include, but are not limited to, using the personal identifiable information and/or requesting additional personal identifiable information, a username and password, a token (e.g., previously provided by the computing device, a service provider associated with the action or the primary user profile or one or more other user profiles, or the like), a direct-to-device process (D2D) (e.g., where the authentication system may transmit a code or link to the user device or to a device associated with the primary user profile or another user profile of the identified user profiles), TrustStamp (e.g., one or more images of a physical identifier of the user), or other information. In some instances, the authentication processes may be defined as a hierarchy based on the first confidence and the second confidence (and/or the overall confidence). The security level may be indicative of a confidence that the authentication process accurately authenticates a user device and/or the user thereof. For example, authenticating the user device and/or the user thereof using personal identifiable information (e.g., by comparing the personal identifiable information to corresponding information of the identified user profiles) may be less secure than a D2D process, and a D2D process may be less secure than a TrustStamp process.

At block 916, the user device executes the dynamic authentication process. In some instances, the authentication system may transmit instructions to the user device enabling the user device to execute the dynamic authentication process. In other instances, the authentication system may transmit an identification of the dynamic authentication process to the user device and the user device may identify instructions (stored in local memory, etc.) to execute the dynamic authentication process. For example, the authentication system may provide an interface identifying the authentication process. The interface may include instructions executable by the user device and or parsable by the user.

At block 920, the user device may establish an authenticated communication session with the authentication system over the second communication channel. The authenticated communication session may be a temporary session that provides access to one or more user profiles associated with the user. In some examples, establishing the authenticated communication session may include encrypting the communications transmitted over the second communication channel. The temporary session may be restricted based on the first confidence, the second confidence, and/or the overall confidence, the purpose or intent for establishing the connection with the authentication system, and/or the like. For instance, the temporary session may restricted to a particular time interval so that the user device may only access the one or more user profiles over the time interval. Once the time interval expires, the temporary session may be terminated. In another example, the temporary session may be limited to one or more actions that can be performed with respect to the one or more user profiles. Once the one or more actions have been executed, the temporary session may be terminated. The temporary session may provide limited access to the one or more user profiles to limit an impact if the user and/or the user device turns out to be an unauthorized user (e.g., an imposter, etc.).

In some examples, establishing the authenticated communication session may include receiving an interface presenting information associated with the one or more user profiles. The interface may be dynamically defined to based on the restrictions of the temporary session and/or access rights of the user device and/or the user thereof. For instance, if the user device lacks authorization to make changes to the one or more user profiles, then the interface may prevent inputs that modify the one or more user profiles.

At block 924, the user device and/or the authentication system facilitates execution of an action associated with a user profile. The action may be associated with the purpose or intent for establishing the connection with the authentication system. Alternatively, or additionally, the action may not be related to the purpose or intent. Instead, the action may correspond to one or more predetermined actions that can be executed based on the temporary session or access rights of the user device and/or the user thereof. For instance, based on the first confidence value, the second confidence value, and/or the overall confidence value, the authentication system may determine what actions may be safe to execute with respect to the one or more user profiles and present the user device a list of those actions while preventing other actions from being executed.

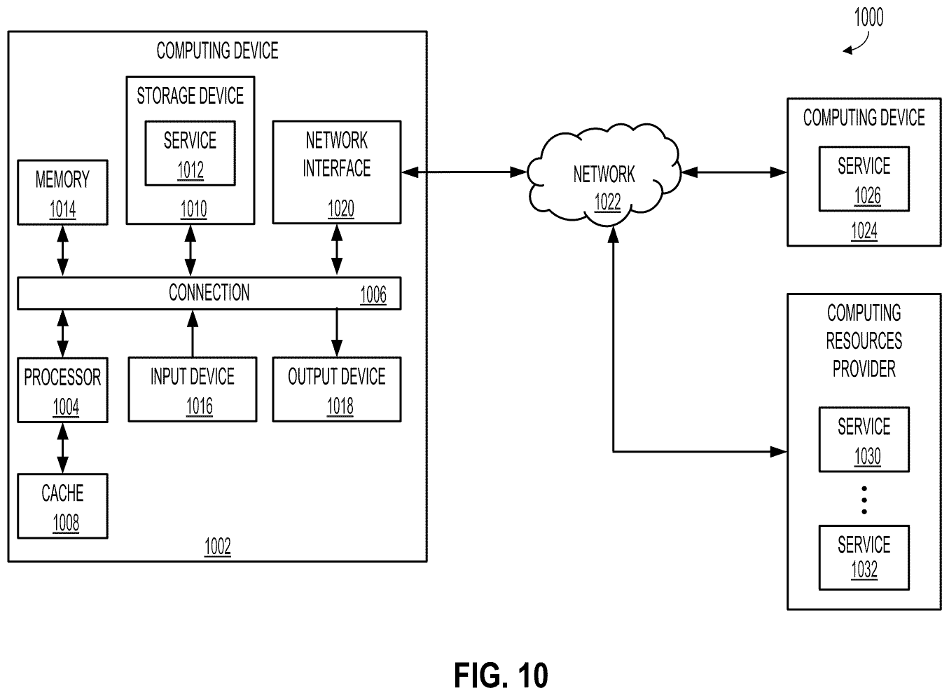

FIG. 10 illustrates a computing system architecture including various components in electrical communication with each other according to aspects of the present disclosure. The example computing system architecture 1000 illustrated in FIG. 10 includes a computing device 1002, which has various components in electrical communication with each other using a connection 1006, such as a bus, in accordance with some implementations. The example computing system architecture 1000 includes a processing unit 1004 that is in electrical communication with various system components, using the connection 1006, and including the system memory 1014. In some embodiments, the system memory 1014 includes read-only memory (ROM), random-access memory (RAM), and other such memory technologies including, but not limited to, those described herein. In some embodiments, the example computing system architecture 1000 includes a cache 1008 of high-speed memory connected directly with, in close proximity to, or integrated as part of the processor 1004. The system architecture 1000 can copy data from the memory 1014 and/or the storage device 1010 to the cache 1008 for quick access by the processor 1004. In this way, the cache 1008 can provide a performance boost that decreases or eliminates processor delays in the processor 1004 due to waiting for data. Using modules, methods and services such as those described herein, the processor 1004 can be configured to perform various actions. In some embodiments, the cache 1008 may include multiple types of cache including, for example, level one (L1) and level two (L2) cache. The memory 1014 may be referred to herein as system memory or computer system memory. The memory 1014 may include, at various times, elements of an operating system, one or more applications, data associated with the operating system or the one or more applications, or other such data associated with the computing device 1002.

Other system memory 1014 can be available for use as well. The memory 1014 can include multiple different types of memory with different performance characteristics. The processor 1004 can include any general-purpose processor and one or more hardware or software services, such as service 1012 stored in storage device 1010, configured to control the processor 1004 as well as a special-purpose processor where software instructions are incorporated into the actual processor design. The processor 1004 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 1004 can be a microprocessor, a microcontroller, a digital signal processor (“DSP”), or a combination of these and/or other types of processors. In some embodiments, the processor 1004 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 1000, an input device 1016 can represent any number of input mechanisms, such as a microphone for speech, a touch-sensitive screen for gesture or graphical input, keyboard, mouse, motion input, pen, and other such input devices. An output device 1018 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 1000. In some embodiments, the input device 1016 and/or the output device 1018 can be coupled to the computing device 1002 using a remote connection device such as, for example, a communication interface such as the network interface 1020 described herein. In such embodiments, the communication interface can govern and manage the input and output received from the attached input device 1016 and/or output device 1018. As may be contemplated, there is no restriction on operating on any particular hardware arrangement and accordingly the basic features here may easily be substituted for other hardware, software, or firmware arrangements as they are developed.

In some embodiments, the storage device 1010 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 1010 can include hardware and/or software services such as service 1012 that can control or configure the processor 1004 to perform one or more functions including, but not limited to, the methods, processes, functions, systems, and services described herein in various embodiments. In some embodiments, the hardware or software services can be implemented as modules. As illustrated in example computing system architecture 1000, the storage device 1010 can be connected to other parts of the computing device 1002 using the system connection 1006. In some embodiments, a hardware service or hardware module such as service 1012, that performs a function can include a software component stored in a non-transitory computer-readable medium that, in connection with the necessary hardware components, such as the processor 1004, connection 1006, cache 1008, storage device 1010, memory 1014, input device 1016, output device 1018, and so forth, can carry out the functions such as those described herein.

The disclosed systems and services (e.g., the authentication systems of FIG. 8-9) can be performed using a computing system such as the example computing system illustrated in FIG. 10, using one or more components of the example computing system architecture 1000. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some examples, the processor can be configured to carry out some or all of methods and systems described in connection with the authentication systems described herein by, for example, executing code using a processor such as processor 1004 wherein the code is stored in memory such as memory 1014 as described herein. One or more of a user device, a provider server or system, a database system, or other such devices, services, or systems may include some or all of the components of the computing system such as the example computing system illustrated in FIG. 10, using one or more components of the example computing system architecture 1000 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital representative (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 1028. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 1004 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 1014 can be coupled to the processor 1004 by, for example, a connector such as connector 1006, or a bus. As used herein, a connector or bus such as connector 1006 is a communications system that transfers data between components within the computing device 1002 and may, in some embodiments, be used to transfer data between computing devices. The connector 1006 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 1014 can include RAM including, but not limited to, dynamic RAM (DRAM), static RAM (SRAM), synchronous dynamic RAM (SDRAM), non-volatile random-access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 1014 can also include magnetic or optical data storage media including read-only (e.g., CD ROM and DVD ROM) or otherwise (e.g., CD or DVD). The memory can be local, remote, or distributed.

As described above, the connector 1006 (or bus) can also couple the processor 1004 to the storage device 1010, which may include non-volatile memory or storage, a drive unit, and/or the like. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 1010. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 1006 can also couple the processor 1004 to a network interface device such as the network interface 1020. The interface can include one or more of a modem or other such network interfaces including, but not limited to those described herein. It will be appreciated that the network interface 1020 may be considered to be part of the computing device 1002 or may be separate from the computing device 1002. The network interface 1020 can include one or more of an analog modem, Integrated Services Digital Network (ISDN) modem, cable modem, token ring interface, satellite transmission interface, or other interfaces for coupling a computer system to other computer systems. In some embodiments, the network interface 1020 can include one or more input and/or output (I/O) devices. The I/O devices can include, by way of example but not limitation, input devices such as input device 1016 and/or output devices such as output device 1018. For example, the network interface 1020 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 1002 can be connected to one or more additional computing devices such as computing device 1024 via a network 1022 using a connection such as the network interface 1020. In such embodiments, the computing device 1024 may execute one or more services 1026 to perform one or more functions under the control of, or on behalf of, programs and/or services operating on computing device 1002. In some embodiments, a computing device such as computing device 1024 may include one or more of the types of components as described in connection with computing device 1002 including, but not limited to, a processor such as processor 1004, a connection such as connection 1006, a cache such as cache 1008, a storage device such as storage device 1010, memory such as memory 1014, an input device such as input device 1016, and an output device such as output device 1018. In such embodiments, the computing device 1024 can carry out the functions such as those described herein in connection with computing device 1002. In some embodiments, the computing device 1002 can be connected to a plurality of computing devices such as computing device 1024, each of which may also be connected to a plurality of computing devices such as computing device 1024. Such an embodiment may be referred to herein as a distributed computing environment.

The network 1022 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 1022 can be wired connections, wireless connections, or combinations thereof. Communications via the network 1022 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 1022, within the computing device 1002, within the computing device 1024, or within the computing resources provider 1028 can include information, which also may be referred to herein as content. The information may include text, graphics, audio, video, haptics, and/or any other information that can be provided to a user of the computing device such as the computing device 1002. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 1002 and presented to a user of the computing device 1002 using forms that are perceptible via sight, sound, smell, taste, touch, or other such mechanisms. In some embodiments, communications over the network 1022 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 1002 and/or the computing device 1024 can be connected to a computing resources provider 1028 via the network 1022 using a network interface such as those described herein (e.g., network interface 1020). In such embodiments, one or more systems (e.g., service 1030 and service 1032) hosted within the computing resources provider 1028 (also referred to herein as within “a computing resources provider environment”) may execute one or more services to perform one or more functions under the control of, or on behalf of, programs and/or services operating on computing device 1002 and/or computing device 1024. Systems such as service 1030 and service 1032 may include one or more computing devices such as those described herein to execute computer code to perform the one or more functions under the control of, or on behalf of, programs and/or services operating on computing device 1002 and/or computing device 1024.

For example, the computing resources provider 1028 may provide a service, operating on service 1030 to store data for the computing device 1002 when, for example, the amount of data that the computing device 1002 exceeds the capacity of storage device 1010. In another example, the computing resources provider 1028 may provide a service to first instantiate a virtual machine (VM) on service 1032, use that VM to access the data stored on service 1032, perform one or more operations on that data, and provide a result of those one or more operations to the computing device 1002. Such operations (e.g., data storage and VM instantiation) may be referred to herein as operating “in the cloud,” “within a cloud computing environment,” or “within a hosted virtual machine environment,” and the computing resources provider 1028 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 1028 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, combinations thereof, or the like. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 1030 and service 1032 may implement versions of various services (e.g., the service 1012 or the service 1026) on behalf of, or under the control of, computing device 1002 and/or computing device 1024. Such implemented versions of various services may involve one or more virtualization techniques so that, for example, it may appear to a user of computing device 1002 that the service 1012 is executing on the computing device 1002 when the service is executing on, for example, service 1030. As may also be contemplated, the various services operating within the computing resources provider 1028 environment may be distributed among various systems within the environment as well as partially distributed onto computing device 1024 and/or computing device 1002.

The following examples illustrate various aspects of the present disclosure. As used below, any reference to a series of examples is to be understood as a reference to each of those examples disjunctively (e.g., “Examples 1-4” is to be understood as “Examples 1, 2, 4, or 4”).

Example 1 is a method comprising: receiving, through a web-based interface, a connection request from a user device, wherein the connection request includes personal identifiable information associated with a current user of the user device; selecting an authentication process from a plurality of authentication processes based on at least a portion of the personal identifiable information; authenticating the user device by executing the authentication process using the portion of the personal identifiable information; establishing a temporary session for the user device, the temporary session enabling execution of one or more actions associated with one or more user profiles; and facilitating execution of at least one action of the one or more actions.

Example 2 is the method of any of example(s) 1 and 3-19, wherein the one or more user profiles correspond to accounts associated with the current user of the user device.

Example 3 is the method of any of example(s) 1-2 and 4-19, wherein the one or more actions are determined based on the authentication process.

Example 4 is the method of any of example(s) 1-3 and 5-19, wherein the at least one action pushes a token into a secure environment of the user device, the token enabling access to a resource associated with a user profile of the one or more user profiles.

Example 5 is the method of any of example(s) 1-4 and 6-19, wherein the at least one action includes a request to increase a resource associated with a user profile of the one or more user profiles.

Example 6 is the method of any of example(s) 1-5 and 7-19, further comprising: identifying, using the personal identifiable information, the one or more user profiles associated with the current user of the user device, wherein selecting an authentication process is further based on the one or more user profiles.

Example 7 is the method of any of example(s) 1-6 and 8-19, wherein the authentication process includes transmitting a request to the user device for information associated with a user profile of the one or more user profiles.

Example 8 is the method of any of example(s) 1-7 and 9-19, wherein the authentication process includes transmitting a request to the user device for additional personal identifiable information.

Example 9 is the method of any of example(s) 1-8 and 10-19, wherein the authentication process includes requesting one or more images of a physical identification card associated with the current user.

Example 10 is the method of any of example(s) 1-9 and 11-19, further comprising: determining that the authentication process failed to authenticate the user device; establishing a connection with the user device over a second communication channel; and executing another authentication process over the second communication channel.

Example 11 is a method comprising: receiving, over a first communication channel, a link to an authentication system; establishing, over a second communication channel, an unsecured communication session with the authentication system; transmitting personal identifiable information associated with a user of a user device over the unsecured communication session, wherein upon being received by the authentication system causes the authentication system to define a dynamic authentication process based on the personal identifiable information and an identification of the first communication channel; executing the dynamic authentication process; establishing, over the second communication channel, an authenticated communication session with the authentication system, wherein the authenticated communication session is a temporary session, and wherein the authenticated communication session provides access to one or more user profiles associated with the user; and facilitating execution of an action associated with a user profile.

Example 12 is the method of any of example(s) 1-11 and 13-19, wherein the first communication channel includes one of a direct message, a text message, an email, a website, a physical or virtual notification, or a telephony connection.

Example 13 is the method of any of example(s) 1-12 and 14-19, wherein executing the dynamic authentication process includes transmitting a token.

Example 14 is the method of any of example(s) 1-13 and 15-19, wherein executing the dynamic authentication process includes transmitting a temporary identifier associated with the user device.

Example 15 is the method of any of example(s) 1-14 and 16-19, wherein executing the dynamic authentication process includes transmitting a cryptographic key.

Example 16 is the method of any of example(s) 1-15 and 17-19, wherein the action includes facilitating a transmission of a temporary token to a terminal device, wherein the temporary token provides access to a resource of the user profile.

Example 17 is the method of any of example(s) 1-16 and 18-19, wherein the action includes provisioning the user device with a temporary token associated with the user profile, wherein the temporary token provides access to a resource of the user profile.

Example 18 is the method of any of example(s) 1-17 and 19, wherein the action includes generating an interface identifying a status of the user profile.

Example 19 is the method of any of example(s) 1-18, wherein the action includes establishing a new user profile associated with the user.

Example 20 is a system comprising: one or more processors; a non-transitory computer-readable medium storing instructions that when executed by the one or more processors, cause the one or more processors to perform the methods of any of example(s) s 1-19.

Example 21 is a non-transitory computer-readable medium storing instructions that when executed by one or more processors, cause the one or more processors to perform the methods of any of example(s) s 1-19.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a keypad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 902) include, but is not limited to, desktop computers, laptop computers, server computers, hand-held computers, tablets, smart phones, personal digital representatives, digital home representatives, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process 800 of FIG. 8). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general-purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital representative (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 902.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed:

1. A method comprising:
receiving, through a web-based interface, a connection request from a user device, wherein the connection request includes personal identifiable information associated with a current user of the user device;
selecting an authentication process from a plurality of authentication processes based on at least a portion of the personal identifiable information;
authenticating the user device by executing the authentication process using the portion of the personal identifiable information;
establishing a temporary session for the user device, the temporary session enabling execution of one or more actions associated with one or more user profiles; and
facilitating execution of at least one action of the one or more actions.

2. The method of claim 1, wherein the one or more user profiles correspond to accounts associated with the current user of the user device.

3. The method of claim 1, wherein the one or more actions are determined based on the authentication process.

4. The method of claim 1, wherein the at least one action pushes a token into a secure environment of the user device, the token enabling access to a resource associated with a user profile of the one or more user profiles.

5. The method of claim 1, wherein the at least one action includes a request to increase a resource associated with a user profile of the one or more user profiles.

6. The method of claim 1, further comprising:
identifying, using the personal identifiable information, the one or more user profiles associated with the current user of the user device, wherein selecting an authentication process is further based on the one or more user profiles.

7. The method of claim 1, wherein the authentication process includes transmitting a request to the user device for information associated with a user profile of the one or more user profiles.

8. A system comprising:
one or more processors;
a non-transitory computer-readable medium storing instructions that when executed by the one or more processors, cause the one or more processors to perform operations including:
receiving, through a web-based interface, a connection request from a user device, wherein the connection request includes personal identifiable information associated with a current user of the user device;
selecting an authentication process from a plurality of authentication processes based on at least a portion of the personal identifiable information;
authenticating the user device by executing the authentication process using the portion of the personal identifiable information;
establishing a temporary session for the user device, the temporary session enabling execution of one or more actions associated with one or more user profiles; and
facilitating execution of at least one action of the one or more actions.

9. The system of claim 8, wherein the one or more user profiles correspond to accounts associated with the current user of the user device.

10. The system of claim 8, wherein the one or more actions are determined based on the authentication process.

11. The system of claim 8, wherein the at least one action pushes a token into a secure environment of the user device, the token enabling access to a resource associated with a user profile of the one or more user profiles.

12. The system of claim 8, wherein the at least one action includes a request to increase a resource associated with a user profile of the one or more user profiles.

13. The system of claim 8, wherein the operations further include:
identifying, using the personal identifiable information, the one or more user profiles associated with the current user of the user device, wherein selecting an authentication process is further based on the one or more user profiles.

14. The system of claim 8, wherein the authentication process includes transmitting a request to the user device for information associated with a user profile of the one or more user profiles.

15. A non-transitory computer-readable medium storing instructions that when executed by one or more processors, cause the one or more processors to perform operations including:
receiving, through a web-based interface, a connection request from a user device, wherein the connection request includes personal identifiable information associated with a current user of the user device;
selecting an authentication process from a plurality of authentication processes based on at least a portion of the personal identifiable information;
authenticating the user device by executing the authentication process using the portion of the personal identifiable information;
establishing a temporary session for the user device, the temporary session enabling execution of one or more actions associated with one or more user profiles; and
facilitating execution of at least one action of the one or more actions.

16. The non-transitory computer-readable medium of claim 15, wherein the one or more user profiles correspond to accounts associated with the current user of the user device.

17. The non-transitory computer-readable medium of claim 15, wherein the one or more actions are determined based on the authentication process.

18. The non-transitory computer-readable medium of claim 15, wherein the at least one action pushes a token into a secure environment of the user device, the token enabling access to a resource associated with a user profile of the one or more user profiles.

19. The non-transitory computer-readable medium of claim 15, wherein the at least one action includes a request to increase a resource associated with a user profile of the one or more user profiles.

20. The non-transitory computer-readable medium of claim 15, wherein the operations further include:
identifying, using the personal identifiable information, the one or more user profiles associated with the current user of the user device, wherein selecting an authentication process is further based on the one or more user profiles.
